(19) United States
(12) Patent Application Publication
(10) Pub. No.: US 2006/0079983 A1
(43) Pub. Date: Apr. 13, 2006

(54) R2R controller to automate the data collection during a DOE

(75) Inventor: James E. Willis, Austin, TX (US)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 10/962,596

(22) Filed: Oct. 13, 2004

(51) Int. Cl. G05B 13/02; G06F 19/00

(52) U.S. Cl. 700/108; 703/2; 700/31; 700/29

(57) ABSTRACT

A system and a computer-implemented method of operating a processing system in which a process model is selected from a menu of process models available from the processing system. In the module and method, an experiment is designed having a number of process runs for characterization of the selected process model. Process runs to collect data are executed on a processing tool coupled to the processing system. The actual process results from the process runs are measured. The process model is solved for coefficients of the process model.

### BACKGROUND OF THE INVENTION

1. Field of the Invention

The invention relates to developing process models for semiconductor wafer processing. More particularly, the invention relates to a run-to-run controller to automate a design of experiments (DOE) technique for developing process models for semiconductor wafer processing.

2. Description of the Related Art

The use of feed forward controllers in semiconductor processing has long been established in the fabrication of semiconductor integrated circuits by semiconductor manufacturing facilities (fabs). Until recently, wafers were treated as a batch or a lot, and the same processing performed on each of the wafers in the lot. The size of the lot varied depending on the manufacturing practices of the fab but was typically limited to a maximum of 25 wafers. Measurements were routinely made on a few wafers in the lot, and adjustments made to the processing based on these sample measurements. This method of control based on sample measurements on the lot and process recipe adjustments for the following lots is known as lot-to-lot control (L2L). The process models and information necessary to modify the process recipes for L2L control were kept and the computations were performed at the fab level. Recently, manufacturers of semiconductor processing equipment (SPE) have included the ability to measure each wafer immediately before and after the processing is performed. The capability to measure each wafer on the processing tool is known as integrated metrology (IM). IM, in turn, permits one to measure and adjust the process recipe at the wafer-to-wafer (W2W) level. Because of the high volume of data collected and the short period of time between the measurements and subsequent processing of the wafer, it is necessary to provide wafer-to-wafer (W2W) control at the tool rather than at the fab level.

The most expensive and time-consuming step in developing a process control model is the execution of the DOE. The science of DOE is well known and taught to process engineers at the university level. The basis for the science is the need to characterize the response of a process to changes in the process recipe about a nominal operating point of the process. For example, in a simple process having only one process input, the response of the process to changes in the process recipe can be determined by measuring the process result at the nominal operating point, changing the process input to another value and measuring the process result at the new operating point. These two points could be used to determine the slope of a line that represents the sensitivity of the process to the single input. If multiple process inputs can affect the process result, the experiment can be repeated for each of the process inputs. Sometimes the process result is not a linear function of the process input and higher order terms such as quadratic or higher order polynomial are required. In this case, the number of experiments required increases significantly. In some cases, the effect of changing one process parameter depends on the value of another process input. In this case, the process model is required to include cross-terms, and this further increases the number of experiments required. One goal of a DOE technique is to determine the optimum number of experiments required to extract the coefficients of the desired process model.

Because of the expense of developing and performing DOEs to develop process models, in many cases the process model is developed based on the experience of a process engineer relying on his or her “gut feel” for the response of the process to changes in the process recipe. Typically, a single wafer is processed and measured, changes are made to process recipe based on this result, the process recipe is modified, and the process repeated until the results meet the requirements of the process. Typically, very little is known or understood about the process and its response to process inputs.

Due to the large number of process runs and the time necessary to gather the information necessary to derive the process models, conventional use of design of experiments techniques often falls short of the goals. For example, while an experimental design set can be generated for execution, the “experience” of the process engineer can bias the experimental setup based on preconceived ideas of which parameters in the process model are the most critical. Moreover, the time involved for the process runs and characterizations of the runs can result in the process engineer, who conventionally oversees the execution and data collection from the design of experiments, short-cutting or circumventing the design sets, resulting in counterproductive results or the execution of unnecessary or useless runs for process model solution.

### SUMMARY OF THE INVENTION

Accordingly, one object of the present invention is to automate the process of performing the DOE steps.

Still another object of the present invention is to decrease the cost and time required for DOE design and process model validation, while at the same time increasing the information about the process and its response to process recipe changes.

Various of these and other objects are provided in the exemplary embodiments discussed more fully below. In brief, the present invention utilizes a novel approach for implementing automated control of a DOE using a run-to-run (R2R) controller as the basis by which the DOE are implemented and the resultant process models developed. The present invention includes those components necessary to develop, perform, and maintain R2R control at the W2W level.

According to one aspect of the present invention, there is provided a novel computer-implemented method for execution on a computer system associated with operation of a processing system, which when executed by the computer system, cause the computer system to: (1) receive a selection of a process model from a menu of process models available for characterization of a processing tool of the processing system, (2) design a number of process runs to characterize the selected process model on the processing tool, (3) direct process runs on the processing tool to collect data for input to the selected process model, (4) obtain actual process results from the process runs, and (5) solve for coefficients of the process model.

According to another aspect, there is provided a novel processing system having a processing module and a controller coupled to the processing module. The controller includes means for performing a substantially automatic design of experiments (DOE) procedure. The means for performing a substantially automatic DOE procedure includes means for selecting a process model, means for designing an experiment to collect process data using the selected process model, means for collecting the data when the number of process runs are performed, and means for determining coefficients for the selected process model using the collected data.

According to still another aspect, there is provided a novel computer-directed system for performing design of experiments techniques on a processing tool. The computer-directed system includes a selection device having a menu of process models available for selection, a process controller coupled to the processing tool for control of the processing tool, a receiver configured to receive process data from executed process runs, and a data processor configured to receive the process data and solve for coefficients of the process model. The process controller is configured to receive from the selection device a selected process model, and includes a memory storing a determination algorithm for determination of a number of process runs required for characterization of the selected process model on the processing tool.

### BRIEF DESCRIPTION OF THE DRAWINGS

A more complete appreciation of various embodiments of the invention and many of the attendant advantages thereof will become readily apparent with reference to the following detailed description, particularly when considered in conjunction with the accompanying drawings, in which:

FIG. 1 shows an exemplary block diagram of a processing system in accordance with one embodiment of the present invention;

FIG. 2 shows a simplified process flow diagram for a DOE process in accordance with one embodiment of the invention;

FIG. 3 shows a flow diagram for a method for determining DOE results in accordance with one embodiment of the invention;

FIG. 4 illustrates an exemplary view of a DOE Control Strategy Screen in accordance with one embodiment of the invention;

FIG. 5 illustrates an exemplary view of Control Plan Screen in accordance with one embodiment of the invention;

FIGS. 6A-6C illustrate exemplary views of R2R Static Recipe Editor screens in accordance with one embodiment of the invention;

FIGS. 7A-7C illustrate DOE Editor screens in accordance with one embodiment of the invention;

FIG. 8 illustrates tables containing a number of experimental runs for a linear model that includes a single parameter;

FIG. 9 illustrates tables containing a number of experimental runs for a quadratic model that includes a single parameter;

FIG. 10 illustrates tables containing a number of experimental runs for a linear model that includes two parameters;

FIG. 11 illustrates tables containing a number of experimental runs for a quadratic model that includes two parameters;

FIG. 12 illustrates tables containing a number of experimental runs for a full-quadratic model that includes two parameters

FIG. 13 illustrates tables containing a number of experimental runs for a linear model that includes three parameters;

FIG. 14 illustrates tables containing a number of experimental runs for a quadratic model that includes three parameters;

FIG. 15 illustrates tables containing a number of experimental runs for a full-quadratic model that includes three parameters;

FIG. 16 illustrates a computer system for implementing various embodiments of the present invention.

### DETAILED DESCRIPTION OF THE EXEMPLARY EMBODIMENTS

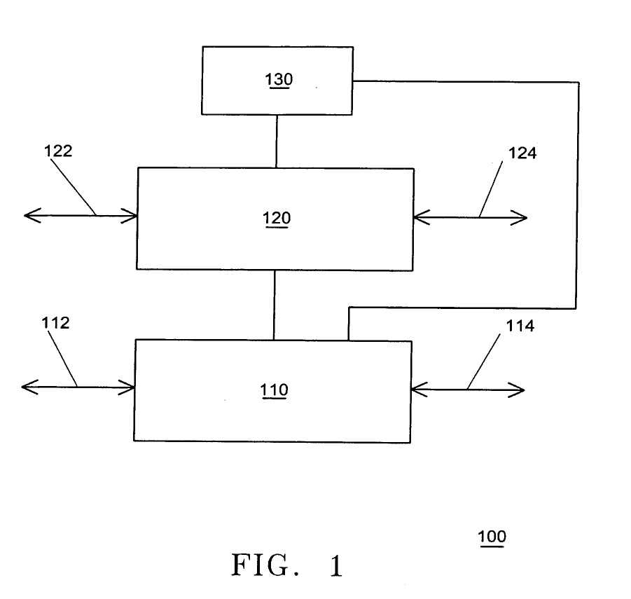

Referring now to the drawings, wherein like reference numerals designate identical, or corresponding parts throughout the several views, and more particularly to FIG. 1, FIG. 1 depicts an exemplary block diagram of a processing system in accordance with one embodiment of the present invention. In the illustrated embodiment, processing system 100 includes a processing tool 110, a controller 120 coupled to the processing tool 110, and a manufacturing equipment system (MES) 130 coupled to the controller 120. In addition, at least one of the processing tool 110, the controller 120, and the MES 130 can include a Graphical User Interface (GUI) component and/or a database component (not shown). In alternate embodiments, the GUI component and/or the database component are not required.

Setup and/or configuration information can be obtained by the processing tool 110 and/or the controller 120 for the MES 130. Factory level business rules contained in the MES 130 (i.e., a factory system) can be used to establish a control hierarchy. For example, the processing tool 110 and/or the controller 120 can operate independently, or can be controlled to some degree by the MES 130 by aid of the factory level business rules. Also, the factory level business rules can be used to determine when a process is paused and/or stopped, and what is done when a process is paused and/or stopped. In addition, factory level business rules can be used to determine when to change a process and how to change the process.

Business rules can be used to specify the action taken for normal processing and the actions taken on exceptional conditions. The actions can include initial model loading, pre-etch metrology data filtering, controller recipe selection, post-etch metrology data filtering, feedback calculation, and model update.

In one aspect of the present invention, business rules can be defined at a control strategy level, a control plan level, or a control model level. Business rules can be assigned to execute whenever a particular context is encountered. When a matching context is encountered at a higher level as well as a lower level, the business rules associated with the higher level can be executed. GUI screens can be used for defining and maintaining the business rules. Business rule definition and assignment can be allowed for users with greater than normal security level. The business rules can be maintained in the database. Documentation and help screens can be provided on how to define, assign, and maintain the business rules.

MES 130 of the present invention can monitor some system processes using data reported from the databases associated with the processing tool 110 and/or the controller 120. Factory level business rules can be used to determine which processes are monitored and which data is used. For example, the processing tool 110 and/or the controller 120 can independently collect data, or the data collection process can be controlled to some degree by the factory system 130. Also, factory level business rules can be used to determine how to manage the data when a process is changed, paused, and/or stopped.

Also, the MES 130 can provide run-time configuration information to the processing tool 110 and/or the controller 120. For example, automated process control (APC) settings, targets, limits, rules, and algorithms can be downloaded from the MES 130 to the processing tool 110 and/or the controller 120 as an “APC recipe”, an “APC system rule”, and “APC recipe parameters” at run-time.

Some setup and/or configuration information can be determined by the processing tool 110 and/or the controller 120 when the processing tool 110 and the controller 120 are initially configured by the system. System level business rules (system rules) can be used to establish a control hierarchy. For example, the processing tool 110 and/or the controller 120 can operate independently, or the processing tool 110 can be controlled to some degree by the controller 120. Also, system rules can be used to determine when a process is paused and/or stopped, and what is done when a process is paused and/or stopped. In addition, system rules can be used to determine when to change a process and how to change the process. Furthermore, a controller 120 can use tool level rules to control some tool level operations.

In general, rules allow system and/or tool operation to change based on the dynamic state of the processing system 100.

In FIG. 1, one processing tool 110 and one controller 120 are shown, but only one processing tool and controller is not required for the present invention. The processing system 100 can include a number of processing tools and can include a number of controllers associated with the processing tools in addition to independent process tools and modules.

The processing tool 110 and/or the controller 120 can be used to configure a number of processing tools having a number of processing tools associated with them in addition to a number of independent process tools and modules. The processing tool 110 and/or the controller 120 can collect, provide, process, store, and display data from processes involving processing tools, processing subsystems, process modules, and sensors.

The processing tool 110 and/or the controller 120 can have a number of applications including at least one tool-related application, at least one module-related application, at least one sensor-related application, at least one interface-related application, at least one database-related application, at least one GUI-related application, and at least one configuration application.

For example, the processing system 100 of the present invention can have an APC system from Tokyo Electron Limited that can include a Unity® Tool, Telius® Tool and/or a Trias® Tool and their associated processing subsystems and process modules. In addition, the processing system 100 can have a R2R controller, such as the Ingenio® TL ES server from Tokyo Electron Limited, and an integrated metrology module (IMM) such as i-MOD® from Tokyo Electron Limited. Alternately, the controller 120 can support other process tools and other process modules.

A GUI component 122 can provide graphical interfaces that permit users for example to:

view tool status and process module status;

create and edit x-y charts of summary and raw (trace) parametric data for selected wafers;

view tool alarm logs;

configure data collection plans that specify conditions for writing data to the database or to output files;

input files to statistical process control (SPC) charting, modeling and spreadsheet programs;

examine wafer processing information for specific wafers, and review data that is currently being saved to the database;

create and edit SPC charts of process parameters, and set SPC alarms which generate e-mail warnings;

run multivariate principal component analysis (PCA) and/or partial least squares (PLS) models; and

view diagnostics screens in order to troubleshoot and report problems with the controller 120.

Raw data and trace data from the processing tool 110 can be stored as files in a database stored in a memory of the processing tool 110. In addition, IM data and host metrology data can be stored in the database. The amount of data depends on the data collection plans that are configured, as well as the frequency with which processes are performed and processing tools are run. The data obtained from the processing tools, the processing chambers, the sensors, and the operating system can be stored in the database.

In one embodiment of the present invention, the processing system 100 includes a client workstation (not shown). The system can support a plurality of client workstations. A client workstation can allow a user to perform configuration procedures; to view status including tool, controller, process, and factory status; to view current and historical data; to perform modeling and charting functions; and to input data to the controller. For example, a user may be provided with administrative rights that allow the user to control one or more processes performed by a controller.

Processing tool 110 and the controller 120 can be coupled to MES 130 and can be part of an electronic-based diagnostic system. The processing tool 110 and/or the controller 120 can exchange information with the MES 130. In addition, the MES 130 can send command and/or override information to the processing tool 110 and/or the controller 120. For example, the MES 130 can feed-forward to the processing tool 110 and/or the controller 120 downloadable recipes for any number of process modules, tools, and measuring devices, with variable parameters for each recipe. Variable parameters can include final critical dimension (CD) targets, limits, offsets, and variables in the tool level system that need to be adjustable by lot. Also, factory litho CD metrology data can be feed-forwarded to the controller 120.

Furthermore, the MES 130 can be used to provide measurement data, such as critical dimension scanning electron microscopy (CD SEM) information, to the controller. Alternately, the CD SEM information can be provided manually. Adjustment factors can be used to adjust for any offset between the IM and CD SEM measurements. Manual and automated input of CD SEM data includes a time stamp, such as a date, for proper insertion in to the history of the feedback control loop in the R2R controller.

Configurable items can be configured as a set of variable parameters sent from the factory system using Generic Equipment Model (GEM) SEMI Equipment Communications Standard (SECS) communications protocol. For example, variable parameters can be passed as part of an “APC Recipe”. An APC recipe may contain more than one sub recipes and each sub recipe can contain variable parameters.

A single processing tool 110 is also shown in FIG. 1, but this is not required for the invention. Alternately, additional processing tools can be used. In one embodiment of the present invention, a processing tool 110 can include one or more processing modules. The processing tool 110 can include at least one of an etch module, a deposition module, a polishing module, a coating module, a developing module, and a thermal treatment module. Such modules permit the processing tool 110 to control respectfully at least one of an etch tool, a deposition tool, a polishing tool, a coating tool, a developing tool, and a thermal treatment tool. Such modules can be stored for example in memory of the processing tool 110 or in memory of the process controller 120.

In one embodiment of the present invention, the processing tool 110 can have links (112 and 114) for coupling to at least one other processing tool and/or controller. For example, other processing tools and/or controllers can be associated with a process that has been performed before this process, and/or other controllers can be associated with a process that is performed after this process. Link 112 and link 114 can be used to feed forward and/or feed back information. For example, feed forward information can include data associated with an in-coming wafer. This data can include lot data, batch data, run data, composition data, and wafer history data. The data can include pre-process data that can be used to establish an input state for a wafer. A first part of the pre-process data can be provided to the controller 120, and a second part of the pre-process data can be provided to the processing tool 110. Alternately, the two parts can be the same data. Such data can be stored for example in memory of the controller 120 or in memory of the processing tool 110.

The processing tool 110 can have a single integrated metrology module (IMM) device (not shown) or multiple measurement devices. The system 100 can include module related measurement devices, tool-related measurement devices, and external measurement devices. Such module data can be stored for example in memory of the controller 120 or in memory of the processing tool 110. For example, data can be obtained from sensors coupled to one or more process modules and sensors coupled to the processing tool. In addition, data can be obtained from an external device such as a SEM tool and an Optical Digital Profiling (ODP) tool. One ODP tool suitable for the present invention is available from Timbre Technologies Inc. (a TEL company) that provides a patented technique for measuring the profile of a feature in a semiconductor device.

The controller 120 can be coupled to processing tool 110 and MES 130, and information such as pre-processing data and post-processing data can be exchanged there between. For example, when an internal reset event is being generated from the tool, the process controller 120 can send a message, such as an alarm, to the MES 130. This can allow the factory system and/or factory personnel to make the necessary changes to minimize the number of wafers at risk after a major change occurs such as those that occur during corrective or preventative maintenance.

While a single controller 120 is shown in FIG. 1, the present invention is not restricted to a single controller. Additional controllers can be used. For example, controller 120 can include a run-to-run (R2R) controller, a feed-forward (FF) controller, a process model controller, a feedback (FB) controller, or a process controller, or a combination of two or more thereof (all not shown in FIG. 1).

Controller 120 can include links (122 and 124) for coupling to at least one other controller. For example, other controllers can be associated with a process that has been performed before this process, and/or other controllers can be associated with a process that is performed after this process. Link 122 and link 124 can be used to feed forward and/or feed back information.

The controller 120 can use the difference between a measured critical dimension of the incoming material (input state) and a target critical dimension (desired state) to predict, select, or calculate a set of process parameters to achieve the desired result of changing the state of the wafer from the input state to the desired state. For example, this predicted set of process parameters can be a first estimate of a recipe to use based on an input state and a desired state. In one embodiment of the present invention, data such as the input state and/or the desired state data can be obtained from a host.

In one case, the controller 120 knows the input state and a model equation for the desired state for the wafer, and the controller determines a set of recipes that can be performed on the wafer to change the wafer from the input state to a processed state. For example, the set of recipes can describe a multi-step process involving a set of process modules.

The time constant for the controller 120 can be based on the time between measurements. When measured data is available after a DOE lot is completed, the controller's time constant can be based on the time between lots. When measured data is available after a DOE wafer is completed, the controller's time constant can be based on the time between DOE wafers. When measurement data is provided real-time during processing, the controller's time constant can be based on processing steps, within a wafer. When measured data is available while a wafer is being processed or after a wafer is completed or after the lot is completed, the controller can have multiple time constants that can be based on the time between process steps, between wafers, and/or between lots.

The controller 120 can be one controller or multiple controllers operating at any point in time. For example, one controller can be in an operating mode while a second controller can be in a monitoring mode. In addition, another controller can be operating in a simulation mode. Any of the controllers can include a single loop or multiple loops, and the loops can have different time constants. For example, loops can be dependent on wafer timing, lot timing, batch timing, chamber timing, tool timing, and/or factory timing.

The controller 120 can operate as a single input single output (SISO) device, as a single input multiple output (SIMO) device, as a multiple input single output (MISO) device, and as a multiple input multiple output (MIMO) device. In addition, inputs and outputs can be within a controller and/or between one or more controllers. For example, when multiple inputs such as critical dimension CD and sidewall angle are being used, inputs and outputs can be fed forward and backward between two modules, (i.e., one for CD control and one for sidewall angle control). In addition, a mask open controller can also be used. In a multi-process case including multiple modules, information can be fed-forward or fed-back from one controller to another controller.

The controller 120 can compute a predicted state for the wafer based on the input state, the process characteristics, and a process model. For example, a trim rate model can be used along with a processing time to compute a predicted trim amount. Alternately, an etch rate model can be used along with a processing time to compute an etch depth, and a deposition rate model can be used along with a processing time to compute a deposition thickness. Also, models can include Statistical Process Control (SPC) charts, Partial Least Squares (PLS) models, Principle Component Analysis (PCA) models, Fault Detection and Classification (FDC) models, and Multivariate Analysis (MVA) models, such as for example those known in the art. Such process model data can be stored for example in memory of the controller 120 or the MES 130.

The controller 120 can receive and utilize externally provided data for process parameter limits in a process module. For example, the controller GUI component provides a mechanism for the manual input of the process parameter limits. In addition, a factory level controller can provide limits for process parameters for each process module.

The controller 120 can receive and execute models created by commercially available modeling software. For example, the controller can receive and execute the above-noted models (PLS, PCA, etc.) that were created by external applications and sent to and stored in the controller.

The controller 120 can include one or more filters (not shown) to filter the metrology data in order to remove the random noise. For example, a filter can be applied to the input or to the output of a controller. In one case, the filter can be applied to the incoming variable for filtering without concern of the method of control (i.e., independent of using a lookup table). This permits the controller to change output variables over a range of control, such as for example, changing a flow rate in small steps, then making a change in pressure, and an incrementing a flow rate change.

An outlier filter can be used to remove outliers that are statistically not valid and should not be considered in the calculation of the mean of a wafer measurement. The outlier filter can be used to eliminate both high and low outliers from the mean. For example, a box and whisker method can be applied to the site metrology data. This method is effective, is simple to maintain without absolute limits, allows one set of filtering limits to be applied to a varying set of incoming CD mean data (i.e., the target can change without effecting the filter limits) and is simple to visualize. With an outlier filter, additional rules need to be maintained (e.g., minimum number of points in a wafer to statistically represent the wafer and the minimum number of wafers to represent a lot.) Such filter algorithms can be stored for example in memory of the controller 120.

A noise filter can be used to remove random noise and stabilize the control loop. For example, an Exponentially Weighed Moving Average (EWMA) or Kalman filter can be applied. When a filter is used, the filter time constant has to be set. In case of EWMA, lambda is the time constant. For example, EWMA calculations can be made using the complete history each time in order to capture data points that are added out of order, by processing date and time. Such filter algorithms can be stored for example in memory of the controller 120.

The controller can send and receive notification of exception conditions. For example, the controller can send and receive notifications to and from a factory level controller or a tool level controller. In addition, a notification can be sent via the e-Diagnostics network, e-mail, or pager after the identification of an exception condition.

The controller 120 can include a database component for archiving input and output data. For example, the controller 120 can archive received inputs, sent outputs, and actions taken by the controller in a searchable database. In addition, the controller 120 can include a mechanism for data backup and restoration. Also, the searchable database can include model information, configuration information, and historical information, and the controller 120 can use the database component to backup and restore model information and model configuration information, both historical and current. Such databases can be stored for example in memory of the controller 120.

The controller 120 can include a web based user interface. For example, the controller can include a web enabled GUI component for viewing the data in the database. The controller 120 can include a security component that can provide for multiple levels of access depending on the permissions granted by a security administrator. The controller 120 can include a set of default models that are provided at installation time, so that the controller 120 can reset to default conditions.

The controller 120 can take various actions in response to an exception, depending on the nature of the exception. The actions taken on exception can be based on the business rules established for the context specified by the system recipe, process recipe, module type, module identification number, load port number, cassette number, lot number, control job ID, process job ID and/or slot number. Such business rules can be stored for example in memory of the controller 120 or the MES 130.

The controller 120 can be use to lessen the expense of developing and performing DOEs to develop process models. The basis for the science is the need to characterize the response of process to changes in the process recipe about the nominal operating point of the process. Process models can include for example linear models, quadratic models, full quadratic models, and higher order polynomial models. Process models can include multiple variables. Such process models can be stored for example in memory of the controller 120.

A process model can provide the relationship between one or more process recipe parameters or set points and one or more process results. One step required to develop a process model is to devise an experiment that is designed to provide the information necessary to correlate the process recipe parameters to the process result. Optimum experimental design that provides the required process information with the fewest number of experiments can be based on DOE methodology. The DOE methodology can be used to identify patterns of changes to process recipes that are optimized to extract a specified amount of information about the process such as the sensitivity of the process to each of the process recipe parameters. The specific DOE patterns required depend on the number of parameters required to characterize the process, the order of the equation that describes the response of the process, and the existence of the process model cross-terms. For example, a typical DOE requires that from 10 to 25 wafers be processed, each requiring a different process recipe.

The next step, after the DOE has been performed and metrology data and process data has been recorded, is to perform an analysis of the data in order to extract the coefficients of the process model. The techniques used vary, but the technique of partial least squares (PLS) is used in one embodiment of the present invention. The result from the PLS analysis is a set of coefficients and process model which represents the response of the process to process recipe changes.

The next step is to apply the process model in order to enable run-to-run process control at the wafer level.

In order to control an N-dimensional process, such as an etch process, the DOE techniques have been extended into an N-dimensional space. Extending the concepts to N-dimensions requires the use of techniques to reduce the number of experiments required to map the desired process space. The purpose of such experiments is to create a process response surface model, which relates the desired process results to the recipe parameters in N-dimensions. The controller 120 uses DOE techniques to determine the optimum number of experiments required to extract the coefficients of the desired process model.

To understand the complexity of the problem, consider the following illustrative non-limiting example. In this example, the process model has three recipe parameters that are used to influence a single output parameter. For example, x₁ can represent chamber pressure, x₂ can represent a flow rate for a first process gas, x₃ can represent a flow rate for a second process gas, and Y can represent an etch rate in a process chamber. In this example, x₁, x₂, and x₃ are the recipe parameters, and Y is the single output parameter. In one embodiment of the present invention, a quadratic model, as shown in Equation 1, can be sufficient to describe the process response over some input parameter space. Alternately, other models can be used.
Y=β₀+β₁x₁+β₂x₂+β₃x₃+β₄x₁²+β₅x₂²+β₆x₃² (1)

Extending this example to N-Dimensions:
Yᵢ=βᵢ₀+βᵢ₁x₁+βᵢ₂x₂+βᵢ₃x₃+βᵢ₄x₁²+βᵢ₅x₂²+βᵢ₆x₃² (2)

Or, in matrix notation:
Y=βX (3)

where Y is a vector of desired outputs, β is a matrix of coefficients and X is the design matrix of recipe parameters. This form of process model assumes the process outputs are only a function of the process inputs and do not depend on the other process outputs or on time.

In one embodiment of the present invention, the process space can be mapped by varying each of the recipe parameters around a point within a nominal operating range. For example, the changes required for each experiment in the DOE technique can be illustrated as a matrix of deviations from a nominal recipe. The deviations can be expressed as a percentage change from the nominal value or as an absolute change from the nominal value. As shown in Table 1, each column in the matrix represents the processing of a single wafer while each row represents the changes to a recipe parameter. Table 1 shown below depicts one example for varying the recipe parameters in order to span the process range before optimization.

For example, each of the recipe parameters may be varied by +/−5% of a nominal point value within the nominal operating range. In Table 1, a “−1” indicates that the particular process variable is set at the lower limit, for example if the variation limit is −5% then the process variable is set to 95% of the nominal point value. In Table 1, a “+1” indicates that the particular process variable is set at the upper limit, for example if the variation limit is +5 % then the process variable is set to 105% of the nominal point value. In Table 1, a “0” indicates that the particular process variable is set at the nominal point value.

TABLE 1

| | Experimental run | | | | | | | | | | | | | | | | | | | | | | | | | | |
|---|---|---|---|---|---|---|---|---|---|---|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 | 26 | 27 |
| x₁ | −1 | −1 | −1 | −1 | −1 | −1 | −1 | −1 | −1 | 0 | 0 | 0 | 0 | 0 | 0 | 0 | 0 | 0 | 1 | 1 | 1 | 1 | 1 | 1 | 1 | 1 | 1 |
| x₂ | −1 | −1 | −1 | 0 | 0 | 0 | 1 | 1 | 1 | −1 | −1 | −1 | 0 | 0 | 0 | 1 | 1 | 1 | −1 | −1 | −1 | 0 | 0 | 0 | 1 | 1 | 1 |
| x₃ | −1 | 0 | 1 | −1 | 0 | 1 | −1 | 0 | 1 | −1 | 0 | 1 | −1 | 0 | 1 | −1 | 0 | 1 | −1 | 0 | 1 | −1 | 0 | 1 | −1 | 0 | 1 |

The total number of runs needed before optimization of the experiment is given by: N=(3*3*3)=27 runs. After optimization using standard design of experiment techniques such as GOSSET to be discussed later, the minimum number of experimental runs required to solve this system of equations is seven (7). One possible set of experiments that provides enough information to solve for the seven coefficients is shown below in Table 2. Table 2 shows one possible experiment that provides enough information to solve for the seven coefficients.

TABLE 2

| | 1 | 2 | 3 | 4 | 5 | 6 | 7 |
|---|---|---|---|---|---|---|---|
| x₁ | −1 | 1 | −1 | −1 | 0 | 0 | 1 |
| x₂ | −1 | 0 | 1 | 1 | 0 | 1 | 1 |
| x₃ | −1 | 1 | −1 | 1 | 0 | 1 | 1 |

In this case, the controller can request that a cassette is loaded that has seven DOE test wafers. Each of the seven DOE test wafers is processed using a different process recipe as shown in Table 2.

In the first process recipe, the three process variables are set to a value that is equal to the nominal value minus a delta value. For example, the first process variable can be a process gas flow rate; the nominal value can be 20 sccm; the delta value can be ten percent; and set value can be (20−2=18 sccm). The second process variable can be a chamber pressure; the nominal value can be 30 mTorr; the delta value can be ten percent; and the set value can be (30−3=27 mTorr). The third process variable can be an input power; the nominal value can be 1000 watts; the delta value can be ten percent; and the set value can be (1000−100=900 watts).

In the fifth process recipe, the three process variables are set to a value that is equal to the nominal value. For example, the first process variable can be a process gas flow rate; the nominal value can be 20 sccm; and set value can be (20 sccm). The second process variable can be a chamber pressure; the nominal value can be 30 mTorr; and the set value can be (30 mTorr). The third process variable can be an input power; the nominal value can be 1000 watts; and the set value can be (1000 watts).

In the seventh process recipe, the three process variables are set to a value that is equal to the nominal value plus a delta value. For example, the first process variable can be a process gas flow rate; the nominal value can be 20 sccm; the delta value can be ten percent; and set value can be (20+2=22 sccm). The second process variable can be a chamber pressure; the nominal value can be 30 mTorr; the delta value can be ten percent; and the set value can be (30+3=33 mTorr). The third process variable can be an input power; the nominal value can be 1000 watts; the delta value can be ten percent; and the set value can be (1000+100=1100 watts).

In the second, third, fourth, and sixth process recipes, various values of the three process variables are used as indicated by the corresponding entries in Table 2.

After each wafer is processed, a process result Yᵢ can be determined. After all the wafers are processed, the model coefficients (β₀, β₁, β₂, β₃, β₄, β₅, and β₆) can be determined.

For example, post-process metrology data can be obtained. Post-process metrology data can be obtained after a time delay that can vary from minutes to days. Post-process metrology data can be used as a part of the feedback control. Also, the site measurement data can be summarized as the statistical value for the control wafer according to some business rules. IM data can be pre-metrology data for one control plan and post-metrology data for a different control plan. Also, the post-process metrology data can be filtered. For example, an outlier rejection filter can be used to remove data points on a wafer that are outliers and are statistically invalid. In other words, those sites that are not reliable can be thrown away and not used in the wafer mean calculation.

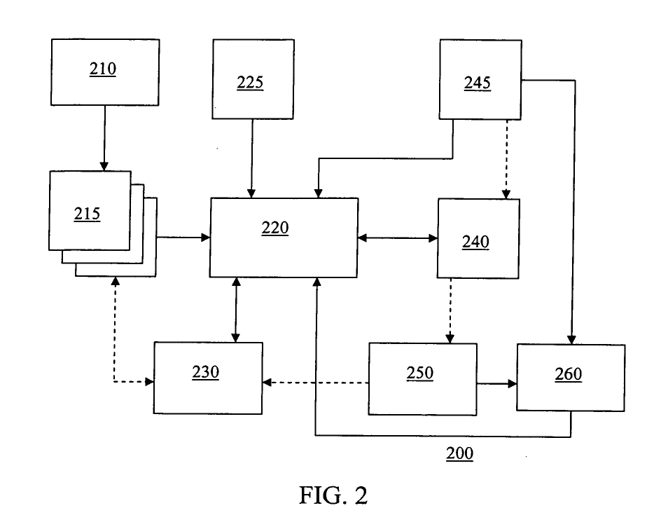

FIG. 2 shows a simplified process flow diagram for a DOE process in accordance with one embodiment of the present invention. In the illustrated embodiment, a process 200 is shown that includes both feed forward and feedback components, but the present invention is not restricted to processes utilizing both feed forward and feedback components. Indeed, a DOE process of the present invention can include a feed forward or a feedback component.

In 210, an input element is shown. In one embodiment, the input element can include context information for a number of different process related components. For example, an input element can include a wafer number(s), a lot identifier(s), a control job identifier(s), a process job identifier(s), a cassette identifier(s), a carrier identifier(s), a slot number(s), a wafer type(s), a scribed wafer identifier(s), a substrate identifier(s), a wafer identifier(s), and a lot start time/end time associated with a particular wafer.

In 215, DOE patterns can be established. In one embodiment of the present invention, a wafer number can be used to determine a DOE pattern. For example, the first wafer number can have the first DOE static recipe associated with it, as for example the run numbers in Table 2. Subsequent wafers in the set of DOE wafers can then have a similar set of context items and can be differentiated from each other by the wafer number. When ten DOE experiments are going to be performed, the different experiments can be differentiated by a wafer number, and each wafer can have a static recipe associated with it based on its wafer number.

In 220, a controller is shown. In one embodiment of the present invention, the controller (such as for example the process controller 120) can include a R2R controller. Alternately, the controller can include a tool level controller and/or a system level controller.

In 225, another input element is shown. In one embodiment of the present invention, this input element can include input data from a processing tool, such as a nominal recipe. For example, a controller can combine a nominal recipe and a static recipe to establish a process recipe to use during a DOE process. In alternate embodiments, additional processing tool information can be provided to the controller.

In 230, a database is shown. In one embodiment of the present invention, the controller can send an output element to the database, and the output element can include an output element for a processing tool, such as a process recipe log. In alternate embodiments, additional processing tool information can be sent by the controller to the database.

In 240, a process module is shown. In one embodiment of the present invention, a process recipe (recipe parameters) can be sent from the controller to the process module 240, and process data can be sent from the process module to the controller. Alternately, other information can be sent and/or received. For example, during a DOE process, a number of “DOE” wafers can be processed at different times in the process module, and the controller can send the correct recipe parameters to the process module for each DOE wafer. In addition, the process module can send process data to the controller.

In 245, a pre-process data component is shown. In one embodiment of the present invention, the pre-process data component can include pre-process metrology data. Pre-process metrology data can be obtained from a metrology tool such as an optical measuring system, an ODP system, a SEM system, and/or a TEM system. For example, pre-process metrology data can include DOE data.

In 250, a post-process data component is shown. In one embodiment of the present invention, the post-process data component can also include pre-process metrology data. Post-process metrology data can be obtained from a metrology tool such as an optical measuring system, an ODP system, a SEM system, and/or a transmission electron microscopy TEM system. For example, post process metrology data can include DOE data. Alternately, post-processing data can include process module data.

In a DOE process, the desired process result can be a process result that is measurable using an optical measuring device. For example, the desired process result can be an etch amount, a deposition amount, a feature and/or via characteristic. After each DOE process run, the desired process result can be measured.

In 260, an actual process result can be obtained. In one embodiment of the present invention, pre-processing data can be compared to post-processing data to determine an actual process result. After each DOE process run, the actual process result can be determined, and a system of equations can be created to solve for the coefficients in the model equation.

In general, process control can include updating a process module recipe using metrology information measured on the wafer prior to its arrival in the process module. In one embodiment of the present invention, the in-coming wafer state can be the same for the wafers used in the DOE, that is the pre-processing data should be the same. The controller can use the pre-processing data to verify that all of the wafers used in the DOE experiments are the same. Alternatively, pre-process and post-process measurements can be used to determine the actual process results.

In the DOE process, the desired process result is the dependent variable in the model equation. The task is to find the coefficients of a model equation that relate a number of process parameters (independent variables) and their interactions to the desired process result.

To summarize, after a model is selected, and the number of DOE experimental runs is determined, then each one of the wafers is processed using a particular process recipe. The process results are used to establish a system of equations, and the system of equations is used to determine the coefficients for the model equation.

When using a DOE methodology, control can be implemented by configuring DOE Control Strategies, DOE Control Plans, and DOE Control Models. A DOE Control Strategy can be established for each desired process result. When the controller executes the DOE Control Strategy, one or more of the Control Plans within the Control Strategy can be executed. Each control plan is used to modify the recipe based on DOE information. The control plans can include one or more static recipes (a fixed recipe) and/or one or more formula models (a model that allows the value of process recipe parameters to vary based on an exact calculation). Such control strategies, plans, and models can be stored for example in memory of the controller 120 or in the memory of MES 130.

The controller can include a recipe parameter solver component that produces recipe parameters according to the appropriate DOE process model, process model constraints, process targets, and process parameter constraints. The controller has the capability of managing multiple process models that are executed at the same time and are subject to a single set of process recipe constraints. The controller can run in three different modes: simulation mode, test mode, and standard mode.

The controller can run in a simulated mode. For example, a R2R controller can operate in a simulation mode in parallel with the actual process mode. In this case, the simulated actions can be recorded in the R2R controller log and historical database, and immediate action is not taken.

During a DOE process, the R2R controller portion of the controller can compute an updated recipe for the next wafer in the DOE lot. A DOE lot can include a number of wafers, and the wafers can be test wafers. The R2R controller calculates the required change to a process parameter

A DOE control strategy can be established for a DOE process, and the control strategy can include a number of control plans. A different control plan can be established for each modified process recipe. A different test wafer can be used for each DOE control plan.

A DOE data collection (analysis) strategy can be established for a DOE process, and the data collection (analysis) strategy can include one or more data collection (analysis) plans. A data collection (analysis) plan can be established for each DOE lot. Measured data can be obtained from each test wafer processed, and the analysis plan can determine if an acceptable error has been obtained.

In one embodiment of the present invention, the DOE model can be a PLS model. Alternately, a different model may be used in other embodiments.

The DOE control and analysis strategies and plans can be stored by the R2R controller and activated when the proper wafer is processed by the processing tool. Wafer context can be used to determine when to perform a DOE control plan and data collection plan. For example, DOE wafers can be processed as an entire lot or as single wafer runs when time and resources can be made available.

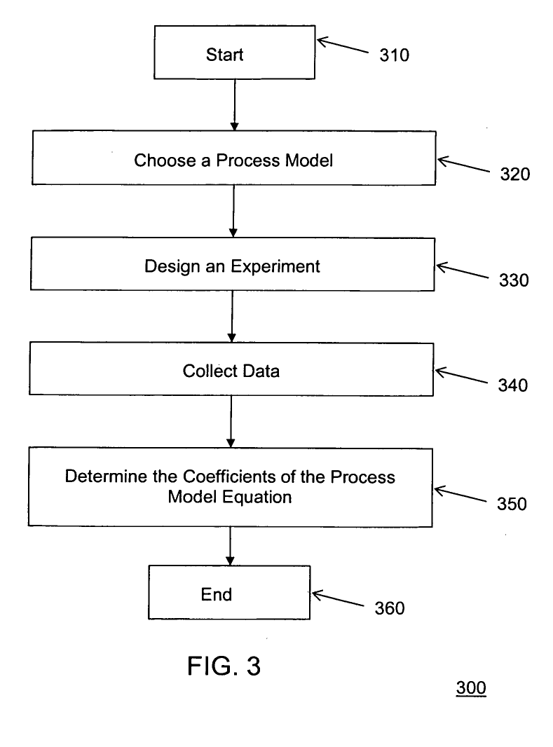

FIG. 3 shows a flow diagram depicting a method for determining DOE results in accordance with one embodiment of the present invention. In the illustrated embodiment, a method used to choose the seven experimental runs is shown. Procedure 300 starts in 310.

In 320, a process model can be chosen. A process model can include cross-product terms in order to include the correlation between process parameters. For example, it could be the case that increasing the flow rate of gas one or two could increase the etch rate of the etcher, while increasing both would have a smaller effect on the etch rate. Alternately, cross-product terms are not required in a process model.

One exemplary model that includes cross terms is shown in Equation 4.
Y=β₀+β₁x₁+β₂x₂+β₃x₃+β₄x₁x₂+β₅x₂x₃+β₆x₁x₃+β₇x₁²+β₈x₂²+β₉x₃² (4)

When the cross terms are added to the model, additional experimental runs are required to solve for the coefficients β₀ through β₉. For example, the minimum number of experimental runs for the model shown in equation 4 is 10 runs.

For example, a DOE control strategy can be created; a DOE control plan can be created; and DOE static recipes and/or formula models can be created. This model equation can be used in a formula model

In 330, an experiment can be designed. An experiment designed to capture the information necessary to extract the coefficients of the process model, including the cross terms is shown below in Table 3.

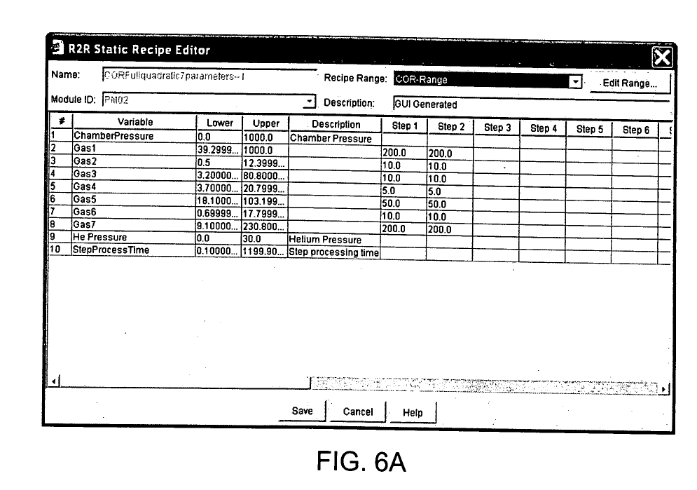

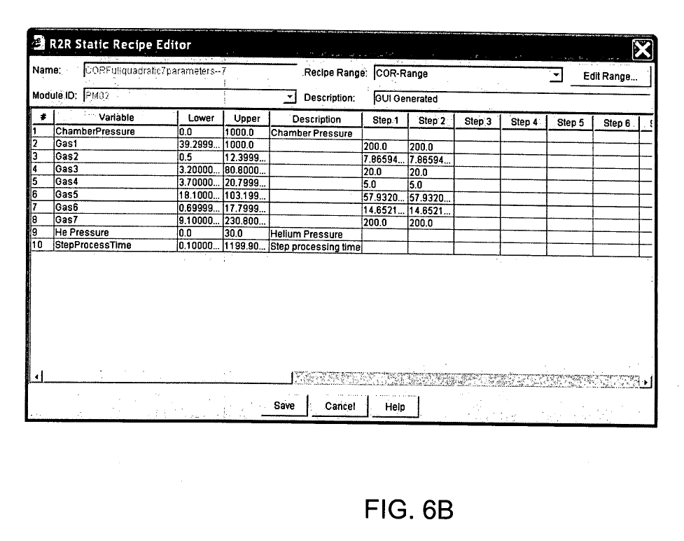

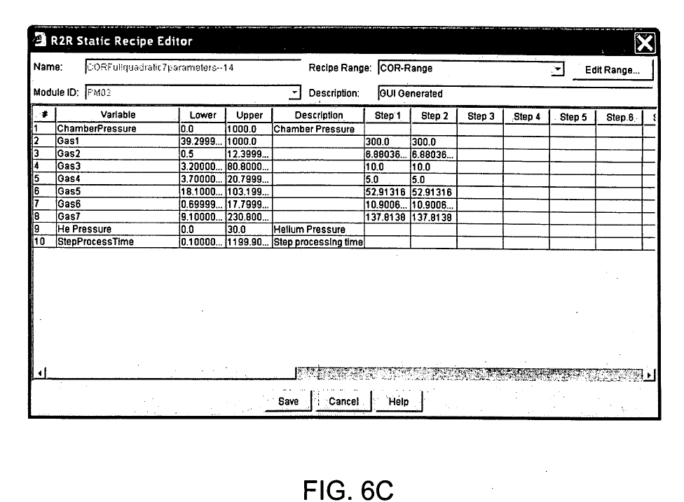

In one embodiment of the present invention, a control plan can be established that includes a number of static recipes. For example, a static recipe can be created for each experimental run. The static recipes can be established by the user or automatically generated by the DOE software. A user can establish a static recipe using a static recipe editor screen as shown in FIGS. 6A-C. Considering the experimental run table shown in Table 3, ten static recipes can be established. The first static recipe can have the three variable process parameters (x₁, x₂, and x₃) set to their lower limit values. The tenth static recipe can have the three variable process parameters (x₁, x₂, and x₃) set to their upper limit values. For example, the three process variables can be chamber pressure, flow rate for a second process gas (gas2), and the flow rate for a third process gas (gas3).

In 340, the data can be collected. Each process output can be assumed independent from the other process outputs as shown Equation 2. A system of linear equations can be formed. The X matrix can be filled with some actual values from the experiment. A process mid-point can be determined. For example, the process mid-point can be chosen to be located at x1=(Chamber Pressure)=10 mTorr, x2=(Flow Rate for Gas2)=12 sccm, and x3=(Flow Rate for Gas4)=16 sccm. Table 4 shows below an exemplary set of recipe parameters that can be used in the experiment to determine the coefficients of Equation 2. The values in Table 4 can be based on the variation as shown in Table 3.

Table 5 shows an example set of measured process results for process output Y1 (e.g., an etch rate) for the exemplary experiment.

TABLE 3

| | Experimental run | | | | | | | | | |
|---|---|---|---|---|---|---|---|---|---|---|
| | 1 | 2 | 3 | 4 | 5 | 6 | 7 | 8 | 9 | 10 |
| x₁ | −1 | −1 | −1 | −1 | 0 | 1 | 1 | 0 | −1 | 1 |
| x₂ | −1 | −1 | 1 | 1 | 0 | −1 | −1 | 1 | 0 | 1 |
| x₃ | −1 | 1 | −1 | 1 | 0 | 1 | −1 | 1 | −1 | 1 |

TABLE 4

| | Experimental run | | | | | | | | | |
|---|---|---|---|---|---|---|---|---|---|---|
| | 1 | 2 | 3 | 4 | 5 | 6 | 7 | 8 | 9 | 10 |
| x₁ | 9 | 9 | 9 | 9 | 10 | 11 | 11 | 10 | 9 | 11 |
| x₂ | 10.8 | 10.8 | 13.2 | 13.2 | 12 | 10.8 | 10.8 | 13.2 | 12 | 13.2 |
| x₃ | 14.4 | 17.6 | 14.4 | 17.6 | 16 | 17.6 | 14.4 | 17.6 | 14.4 | 17.6 |

TABLE 5

| | Experimental run | | | | | | | | | |
|---|---|---|---|---|---|---|---|---|---|---|
| | 1 | 2 | 3 | 4 | 5 | 6 | 7 | 8 | 9 | 10 |
| y₁ | 48.882 | 48.428 | 48.616 | 48.2384 | 50.64 | 52.384 | 52.9024 | 50.1784 | 48.8212 | 52.2184 |

In 350, the coefficients of the process model can be determined. Solving the model equation for the coefficients β involves the following steps.
Y=βX
YX^{T}=βXX^{T}
YX^{T}(XX^{T})⁻¹=β(XX^{T)}(XX^{T})⁻¹
YX^{T}(XX^{T})⁻¹=β (5)

The solution of this system of equations depends on the existence of the inverse matrix (XX^{T})⁻¹. Table 6 shown below depicts an example of a design matrix X based on the process input variation shown in Table 4.

Table 7 shown below depicts example coefficients extracted from the exemplary experiment.

In one embodiment of the present invention, the minimum number of runs required to solve for the coefficients of the process model can be determined. In one example, the method determines a process model and the number of coefficients in the process model, and uses an identical number of experimental runs. This is minimum number required (i.e., the number of equations equals the number of unknowns). In other cases, the method is verified.

The next step in the method is to verify that the experiment that has been chosen can be used to extract the coefficients of the process model. The verification process depends on the existence of the inverse matrix:
(XX^{T})⁻¹ (5)

Matrix X is known as the design matrix, and matrix X is based on the design of the experiment. X^{T} is the inverse of the design matrix. For a matrix to have an inverse, the determinant of the matrix must be non-zero.

Table 8 shown below depicts an example design matrix in which each row in the design matrix is found by combinations of the input parameter as given by the process in Equation 3.

Table 9 shown below depicts an example of an experiment designed to extract the coefficients of Equation 7.

TABLE 6

| X | 1 | 2 | 3 | 4 | 5 | 6 | 7 | 8 | 9 | 10 |
|---|---|---|---|---|---|---|---|---|---|---|
| β₀ | 1 | 1 | 1 | 1 | 1 | 1 | 1 | 1 | 1 | 1 |
| X₁ | 9 | 9 | 9 | 9 | 10 | 11 | 11 | 10 | 9 | 11 |
| X₂ | 10.8 | 10.8 | 13.2 | 13.2 | 12 | 10.8 | 10.8 | 13.2 | 12 | 13.2 |
| X₃ | 14.4 | 17.6 | 14.4 | 17.6 | 16 | 17.6 | 14.4 | 17.6 | 14.4 | 17.6 |
| X₁² | 81 | 81 | 81 | 81 | 100 | 121 | 121 | 100 | 81 | 121 |
| X₂² | 116.64 | 117 | 174 | 174 | 144 | 116.6 | 116.6 | 174 | 144 | 174.2 |
| X₃² | 207.36 | 310 | 207 | 310 | 256 | 309.8 | 207.4 | 310 | 207.4 | 309.8 |
| X₁X₂ | 97.2 | 97.2 | 119 | 119 | 120 | 118.8 | 118.8 | 132 | 108 | 145.2 |
| X₁X₃ | 129.6 | 158 | 130 | 158 | 160 | 193.6 | 158.4 | 176 | 129.6 | 193.6 |
| X₂X₃ | 155.52 | 190 | 190 | 232 | 192 | 190.1 | 155.5 | 232 | 172.8 | 232.3 |

TABLE 7

| β₀ | β₁ | β₂ | β₃ | β₄ | β₅ | β₆ | β₇ | β₈ | β₉ |
|---|---|---|---|---|---|---|---|---|---|
| 25.000 | 1.100 | 0.900 | 0.800 | 0.050 | −0.050 | −0.030 | 0.005 | −0.010 | 0.010 |

Table 10 shown below depicts an example of the variation in the design matrix based on variations in the experiment.

Table 11 shown below depicts an example of a matrix X times its transpose for the 10×10 example. For example, the determinant for this matrix is 262144, indicating the matrix has an inverse.

Procedure 300 can end in 360.

A number of methods have been discovered to go from process model to DOE, and some examples of optimized experiments based on a given process model are presented herein.

TABLE 8

| | Run | | | | | | | | | |
|---|---|---|---|---|---|---|---|---|---|---|
| | 1 | 2 | 3 | 4 | 5 | 6 | 7 | 8 | 9 | 10 |
| β₀ | 1 | 1 | 1 | 1 | 1 | 1 | 1 | 1 | 1 | 1 |
| β₁ | X_{1,1} | X_{1,2} | X_{1,3} | X_{1,4} | X_{1,5} | . | . | . | . | X_{1,10} |
| β₂ | X_{2,1} | X_{2,2} | X_{2,3} | X_{2,4} | X_{2,5} | . | | | | X_{2,10} |
| β₃ | X_{3,1} | X_{3,2} | X_{3,3} | X_{3,4} | X_{3,5} | . | | | | X_{3,10} |
| β₄ | X_{1,1}² | X_{1,2}² | X_{1,3}² | X_{1,4}² | X_{1,5}² | . | | | | X_{1,10}² |
| β₅ | X_{2,1}² | X_{2,2}² | X_{2,3}² | X_{2,4}² | X_{2,5}² | . | | | | X_{2,10}² |
| β₆ | X_{3,1}² | X_{3,2}² | X_{3,3}² | X_{3,4}² | X_{3,5}² | . | | | | X_{3,10}² |
| β₇ | X_{1,1}X_{2,1} | X_{1,2}X_{2,2} | X_{1,3}X_{2,3} | X_{1,4}X_{2,4} | X_{1,5}X_{2,5} | . | | | | X_{1,10}X_{2,10} |
| β₈ | X_{1,1}X_{3,1} | X_{1,2}X_{3,2} | X_{1,3}X_{3,3} | X_{1,4}X_{3,4} | X_{1,5}X_{3,5} | . | | | | X_{1,10}X_{3,10} |
| β₉ | X_{2,1}X_{3,1} | X_{2,2}X_{3,2} | X_{2,3}X_{3,3} | X_{2,4}X_{3,4} | X_{2,5}X_{3,5} | X_{2,6}X_{3,6} | X_{2,7}X_{3,7} | X_{2,8}X_{3,8} | X_{2,9}X_{3,9} | X_{2,10}X_{3,10} |

TABLE 9

| | Experimental run | | | | | | | | | |
|---|---|---|---|---|---|---|---|---|---|---|
| | 1 | 2 | 3 | 4 | 5 | 6 | 7 | 8 | 9 | 10 |
| x₁ | −1 | −1 | −1 | −1 | 0 | 1 | 1 | 0 | −1 | 1 |
| x₂ | −1 | −1 | 1 | 1 | 0 | −1 | −1 | 1 | 0 | 1 |
| x₃ | −1 | 1 | −1 | 1 | 0 | 1 | −1 | 1 | −1 | 1 |

TABLE 10

| X | 1 | 2 | 3 | 4 | 5 | 6 | 7 | 8 | 9 | 10 |
|---|---|---|---|---|---|---|---|---|---|---|
| β₀ | 1 | 1 | 1 | 1 | 1 | 1 | 1 | 1 | 1 | 1 |
| X₁ | −1 | −1 | −1 | −1 | 0 | 1 | 1 | 0 | −1 | 1 |
| X₂ | −1 | −1 | 1 | 1 | 0 | −1 | −1 | 1 | 0 | 1 |
| X₃ | −1 | 1 | −1 | 1 | 0 | 1 | −1 | 1 | −1 | 1 |
| X₁² | 1 | 1 | 1 | 1 | 0 | 1 | 1 | 0 | 1 | 1 |
| X₂² | 1 | 1 | 1 | 1 | 0 | 1 | 1 | 1 | 0 | 1 |
| X₃² | 1 | 1 | 1 | 1 | 0 | 1 | 1 | 1 | 1 | 1 |
| X₁X₂ | 1 | 1 | −1 | −1 | 0 | −1 | −1 | 0 | 0 | 1 |
| X₁X₃ | 1 | −1 | 1 | −1 | 0 | 1 | −1 | 0 | 1 | 1 |
| X₂X₃ | 1 | −1 | −1 | 1 | 0 | −1 | 1 | 1 | 0 | 1 |

An exemplary quadratic model (equation 7), having a single process parameter x₁ and three coefficients β₀, β₁, and β₂ can be characterized using the experimental runs shown in Table 12. For example, three experimental runs can be used.
Y=β₀+β₁x₁+β₂x₁² (7)

An exemplary quadratic model (equation 8), having two process parameters x₁, x₂ and five coefficients β₀, β₁, β₂, β₃, and β₄ can be characterized using the experimental runs shown in Table 13. For example, five experimental runs can be used.
Y=β₀+β₁x₁+β₂x₂+β₃x₁²+β₄x₂² (8)

TABLE 11

| XX^{T} | β₀ | X₁ | X₂ | X₃ | X₁² | X₂² | X₃² | X₁X₂ | X₁X₃ | X₂X₃ |
|---|---|---|---|---|---|---|---|---|---|---|
| β₀ | 10 | −2 | 0 | 1 | 8 | 8 | 9 | −1 | 2 | 2 |
| X₁ | −2 | 8 | −1 | 2 | −2 | −1 | −2 | −1 | 0 | 1 |
| X₂ | 0 | −1 | 8 | 2 | −1 | 0 | 0 | −1 | 1 | 2 |
| X₃ | 1 | 2 | 2 | 9 | 0 | 2 | 1 | 1 | −2 | 0 |
| X₁² | 8 | −2 | −1 | 0 | 8 | 7 | 8 | −1 | 2 | 1 |
| X₂² | 8 | −1 | 0 | 2 | 7 | 8 | 8 | −1 | 1 | 2 |
| X₃² | 9 | −2 | 0 | 1 | 8 | 8 | 9 | −1 | 2 | 2 |
| X₁X₂ | −1 | −1 | −1 | 1 | −1 | −1 | −1 | 7 | 1 | 1 |
| X₁X₃ | 2 | 0 | 1 | −2 | 2 | 1 | 2 | 1 | 8 | −1 |
| X₂X₃ | 2 | 1 | 2 | 0 | 1 | 2 | 2 | 1 | −1 | 8 |

TABLE 12

| | Run | | |
|---|---|---|---|
| | 1 | 2 | 3 |
| x₁ | −1 | 0 | 1 |

TABLE 13

| | Run> | | | | |
|---|---|---|---|---|---|
| | 1 | 2 | 3 | 4 | 5 |
| x₁ | −1 | 0 | 1 | 1 | 0 |
| x₂ | −1 | 0 | 1 | 0 | −1 |

An exemplary quadratic model (equation 9), having three process parameters x₁, x₂, x₃ and seven coefficients β₀, β₁, β₂, β₃, β₄, β₅, and β₆ can be characterized using the experimental runs shown in Table 14. For example, seven experimental runs can be used.
Y=β₀+β₁x₁+β₂x₂+β₃x₃+β₄x₁²+β₅x₂²+β₆x₃² (9)

TABLE 14

| | Run> | | | | | | |
|---|---|---|---|---|---|---|---|
| | 1 | 2 | 3 | 4 | 5 | 6 | 7 |
| x₁ | −1 | 0 | 1 | 0 | 1 | 1 | −1 |
| x₂ | −1 | 0 | 1 | −1 | 0 | −1 | 1 |
| x₃ | −1 | 0 | 1 | −1 | 1 | 0 | −1 |

An exemplary full quadratic model (equation 10), having three process parameters x₁, x₂, x₃ and ten coefficients β₀, β₁, β₂, β₃, β₄, β₅, β₆, β₇, β₈, and β₉ can be characterized using the experimental runs shown in Table 15. For example, ten experimental runs can be used.
Y=β₀+β₁x₁+β₂x₂+β₃x₃+β₄x₁x₂+β₅x₂x₃+β₆x₁x₃+β₇x₁²+β₈x₂²+β₉x₃² (10)

TABLE 15

| | Run> | | | | | | | | | |
|---|---|---|---|---|---|---|---|---|---|---|
| | 1 | 2 | 3 | 4 | 5 | 6 | 7 | 8 | 9 | 10 |
| x₁ | −1 | −1 | −1 | −1 | 0 | 1 | 1 | 0 | −1 | 1 |
| x₂ | −1 | −1 | 1 | 1 | 0 | −1 | −1 | 1 | 0 | 1 |
| x₃ | −1 | 1 | −1 | 1 | 0 | 1 | −1 | 1 | −1 | 1 |

In one embodiment of the present invention, the GOSSET® program can be used to find the optimum DOEs for a variety of simple models. The Gosset program was developed at AT&T Bell Labs in 1991-1994 by R. H. Hardin and N. J. A. Sloane, and is copyrighted 1991-1994 by R. H. Hardin and N. J. A. Sloane. Alternately, other methods can be used. Other techniques known for design of experiments include those in U.S. Pat. No. 5,933,348 to Kurtzberg et al, the entire contents of which are incorporated herein by reference.

The problem of finding the “best” DOE for a particular process model is addressed by the GOSSET program, which is one suitable process model for finding the optimum DOE for a particular system in the present invention. R. H. Hardin and N. J. A. Sloane, developed “GOSSET: A general-purpose program for designing experiments”, and further information concerning the GOSSET program can be obtained at a web site at the following location:

(www.research.att.com/˜njas/gosset/).

Gosset® is known to be a flexible and powerful program for constructing experimental designs. Gosset® runs under Unix, Linux and Mac OS X. The following are some of features of Gosset®. Variables may be discrete or continuous (or both). Discrete variables may be numeric or symbolic (or both). Continuous variables may range over a cube or a ball (or both). The variables may be required to satisfy linear equalities or inequalities. The model to be fitted may be any low degree polynomial (e.g. a quadratic). The number of observations is specified by the user. The design may be required to include a specified set of points. The region where the model is to be fitted need not be the same as the region where measurements are to be made (so the designs can be used for extrapolation). The following types of designs can be requested: I-, A-, D- or E-optimal, the same but with protection against loss of one trial, or packings (if no model is available). Blocked designs and designs with correlated errors can also be obtained. The algorithm in Gosset® is powerful enough to routinely minimize functions of 1000 variables (e.g. can find optimal or nearly optimal designs for a quadratic model involving 12 variables). An extensive library of precomputed optimal designs is included in Gosset® for linear and quadratic designs in the cube, ball and simplex, involving up to 14 variables. The user does not have to specify starting points for the search. The user also has control over how much effort is expended by the algorithm, and can if desired monitor the progress of the search. Gosset® is described in more detail in the following documents, the entire contents of which are incorporated by reference: R. H. Hardin and N. J. A. Sloane, “A New Approach to the Construction of Optimal Designs”, J. Statistical Planning and Inference, vol. 37, 1993, pp. 339-369; R. H. Hardin and N. J. A. Sloane, “Computer-Generated Minimal (and Larger) Response Surface Designs: (I) The Sphere”; and R. H. Hardin and N. J. A. Sloane, “Computer-Generated Minimal (and Larger) Response Surface Designs: (II) The Cube”.

The algorithm used in the GOSSET® program is capable of minimizing a number of differentiable optimality criterion, including the above-noted I-, A-, D- and E-optimalities.

The modeling region is the region where one wants to fit the model. This need not be the same as the measurement region, i.e., the region where one can actually make measurements. If it is not the same, this is indicated by defining a second set of variables, one for each of the original variables, but now marked with primes, which specify the modeling region.

The GOSSET® program can be used to find optimum (or nearly optimum) DOEs for linear, quadratic, and full quadratic models having one or more parameters. In some example cases, four DOEs can be calculated for each case, one having the minimum number of runs, one having the minimum number plus 1, one having the minimum number plus 2, and one having the minimum number plus 3. In addition, other examples can be computed in which each of the cases is re-calculated assuming that one of the runs would be lost during the course of running the experiment, and these runs are tolerant of dropping one of any of the runs specified in the DOE without loosing the capability to solve the process model characterization.

The process of creating the process models requires an understanding of the mechanics of experimental design, execution of an appropriate experiment and analysis of the resultant experimental data. This process can be highly automated and integrated into the semiconductor processing tool using the technique described herein.

In one embodiment of the present invention, “Control Strategies” can be used. For example, control strategies can be selected based on the system recipe. Each control strategy that matches the context can be executed. Control strategies can be evaluated on a “wafer by wafer” basis. Control strategies can contain one or more control plans. Control plans can contain the control model. When multiple control models are executed at the same time, outputs from the previous model may be used as inputs to the second model. There is at least one control plan for each process module being controlled.

A R2R controller of the present invention can include one or more control strategies. The control strategy contains the system recipe to be matched and other context matching criteria. A control strategy contains one or more control plan(s). The control plans contain the information necessary to select the control model(s) to be executed. Control plans are associated with one and only one process module. Therefore, there needs to be at least one control plan for each process module that is being controlled. For example, the control models can be table driven. All configuration information can be saved in the database.

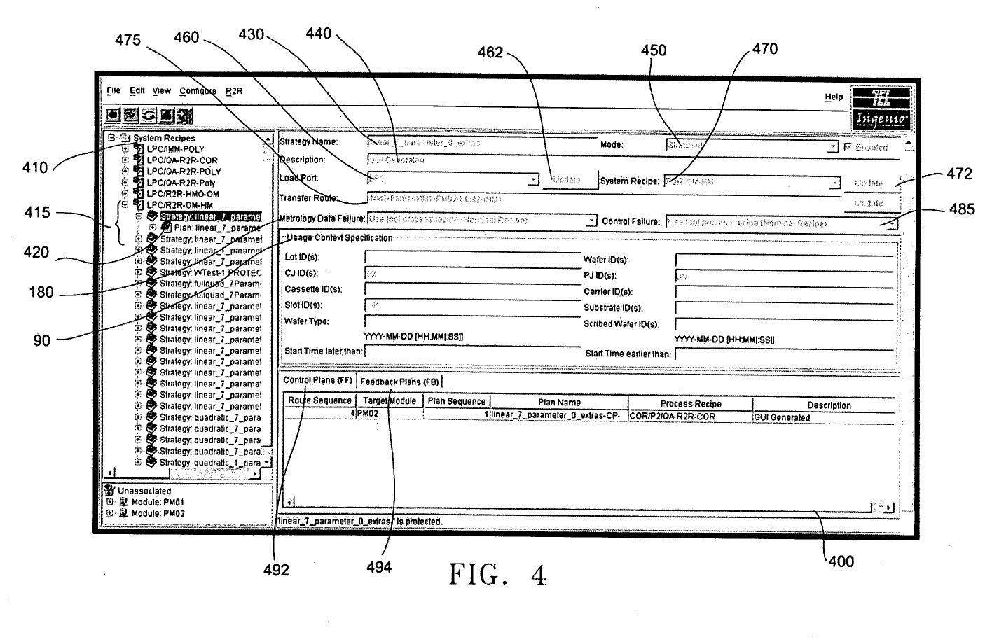

FIG. 4 illustrates an exemplary view of a DOE Control Strategy Screen 400 in accordance with one embodiment of the present invention. The control strategy screen 400 contains the system recipe 410 to be matched and other context matching criteria. The control strategy screen 400 also contains several independent control plans 420 that contain the information necessary to select the control model(s) to be executed. The control strategy screen 400 permits users to download system recipes with control chamber flags or manually input the system recipe name with a transfer route. Also, users can optionally create some context matching criteria.

A DOE control strategy screen 400 of the present invention can include a number of configuration items. The Strategy Name field 430 can be used enter/edit a DOE Control Strategy name. A Description field 440 can be used to enter/edit a DOE Control Strategy Description. The mode field 450 can be used to enter/edit a mode for the DOE Control Strategy. For example, modes can include a standard mode and a simulation mode. An enabled box can be used enable or disable a DOE Control Strategy

A Load Port field 460 can be used to obtain a list of load port information from the processing tool. A Load Port Update Button 462 can be used as a refresh function, and can be used to obtain the current load port information from the processing tool.

A System Recipe field 470 can be used to obtain a list of system recipes from the processing tool. A System Recipe Update button 472 can be used as a refresh function, and can be used to obtain the current recipe information from the processing tool. For example, the system recipe name can be used to trigger the DOE control strategy by matching one or more context items such as the system recipe name.

A Transfer Route field 475 can be used to obtain the transfer route for selected load port and system recipe from the processing tool. A Transfer Route Update button 476 can be used as a refresh function, and can be used to obtain the current recipe information from the processing tool.

The Metrology Data Failure field 480 can be used to enter/edit the metrology data failure action from the following options: Use Tool Process Recipe (Nominal Recipe)—the software sends the indication to the process tool and the process tool uses the tool process recipe. Do Not Use Process Recipe (Null Recipe)—The software sends the null recipe information associated with the wafer to the process tool and the wafer goes in and out of the chamber without being processed. For example, a PM Pause command can be used to pause the process module, and a System Pause command can be used to pause the system including transfer system.

The Control Failure field 485 can be used to enter/edit the Control Failure option from the following options: Use Tool Process Recipe (Nominal Recipe)—the software sends the indication to the process tool and the process tool uses the tool process recipe. Do Not Use Process Recipe (Null Recipe)—The software sends the null recipe information associated with the wafer to the process tool and the wafer goes in and out of the chamber without being processed. PM Pause—Pauses the process module, and System Pause—Pauses the system including transfer system.

A tool level and/or system level controller can detect control failures. If control failure occurs, the user can configure the system software (e.g., Ingenio®) to use the tool process recipe (nominal recipe), use the null recipe, or to stop R2R control (according to tool parameter settings). To pause the tool, the user can configure the system to pause the process module, or to pause the entire system.

For example, if the setting is Continue, the processing tool (e.g., Telius®) may display a warning alarm and can continue lot-processing using the process recipe specified in the system recipe. If the setting is Pause, the processing tool (e.g., Telius®) can pause and display an alarm with action options. This allows the operator to decide whether to continue lot-processing with the process recipe or to abort the wafer. Aborting the wafer permits the R2R control to continue.

In addition, a number of Usage Context Specification fields 490 can be used to provide additional context matching items when these additional context items are required. A LotID(s) field can be used to enter/edit the lot identifiers; a Wafer ID(s) field can be used to enter/edit the wafer identifiers; a CJID(s) field can be used to enter/edit the control job identifiers; a PJID(s) field can be used to enter/edit the process job identifiers; a Cassette ID(s) field can be used to enter/edit the cassette identifiers; a Carrier ID(s) field can be used to enter/edit the carrier identifiers; a Slot(s) field can be used to enter/edit the slot numbers; a Substrate ID(s) field can be used to enter/edit the substrate identifiers; a Wafer Type(s) field can be used to enter/edit the wafer types; a Scribed Wafer ID(s) field can be used to enter/edit the scribed wafer identifiers; one Start Time field can be used to enter/edit the start time; and a second Start Time field can be used to enter/edit the end time.

As shown in FIG. 4, a DOE Control Strategy can include in one embodiment of the present invention one or more DOE control plans. In addition, the Control (feed forward) Plans tab 492 and the Feedback Plans tab 494 can be used to create a new DOE control plan, associate a DOE control plan with a DOE Control Strategy, and edit a DOE control plan.

In the illustrated embodiment shown in FIG. 4, a Control Strategy Navigator panel 415 is shown on the left side of the control ctrategy screen 400. In the illustrated embodiment, a navigation tree (i.e., 410, 415, and 420) is shown having several sublevels. Alternately, other selection means can be used such as selection tabs or buttons. For example, selection tabs can include left-to-right tabs, right-to-left tabs, top-to-bottom tabs, and bottom-to-top tabs. In alternate embodiments of the present invention, navigation trees can be displayed in different languages and can be ordered and positioned differently.

The first level shown is the tool level, but this is not required for the present invention. Alternately, a system level or other higher level group can be shown. For example, a tool level can be associated with an etching tool, a deposition tool, a cleaning tool, a transfer tool, or other semiconductor processing tool. A Recipe Range level is also shown, but this is not required. A Recipe Range level can be used to enter/edit a recipe range for one or more process modules. A System Recipe level can be used to enter/edit system recipe information.

A recipe range is a set of allowable ranges for each parameter. At installation, a default recipe range will be created on each module spanning the entire operating range for each parameter that can be manipulated by the run to run controller. New recipe ranges can then be created for each module with limits stricter than the default ranges. In addition, in the recipe range the user can disable certain parameters from being manipulated by the controller. As formula models and static recipes are created, these models and recipes are linked to recipe ranges for the set of available parameters for control and limits on those parameters. If a formula model attempts to set a value outside the associated recipe range, then an alarm can be generated.

The navigation list can include one or more different types of DOE Control Strategies (i.e., Standard and Simulation). A standard control strategy is integrated with the process tool. The simulation control strategy is associated with one or more simulation control plan(s). Based on the model selected, the control plan can select the recipe variables. The recipe variables established during a simulation run can be stored in the database, but are not sent to process tool. Multiple Simulation control strategies can be executed simultaneously, but only one standard type of control plan can be executed for a given wafer. A standard control strategy can be moved from the standard folder to the simulation folder. A simulation control strategy can be moved to a standard folder only if the corresponding system recipe has been downloaded from the tool. Protected control strategies can be identified, and the protected control strategies can be executed.

Control strategies can be created and for a number of different DOE models and a different number of experimental runs.

Using a control strategy screen 400, such as shown in FIG. 4, a user can perform a DOE Control Strategy configuration, view an existing DOE Control Strategy, create a new DOE Control Strategy, copy an existing DOE Control Strategy, edit an existing DOE Control Strategy, delete an existing Doe Control Strategy, and test a DOE Control Strategy. For example, a dropdown list can be used to select a course of action. Such access and interactive design of the DOE plan permit the user to establish upfront a methodology by which the process under consideration can be characterized and the process response mapped. Interaction at this point in the DOE design by the user can allow his intuition to contribute to the experimental design without risk that the design will not be optimized for proper characterization of the processing system. Further, interaction at this point does not contravene existing control strategies, as the user's input is restricted to menu selections such as for example the above-noted dropdown list.

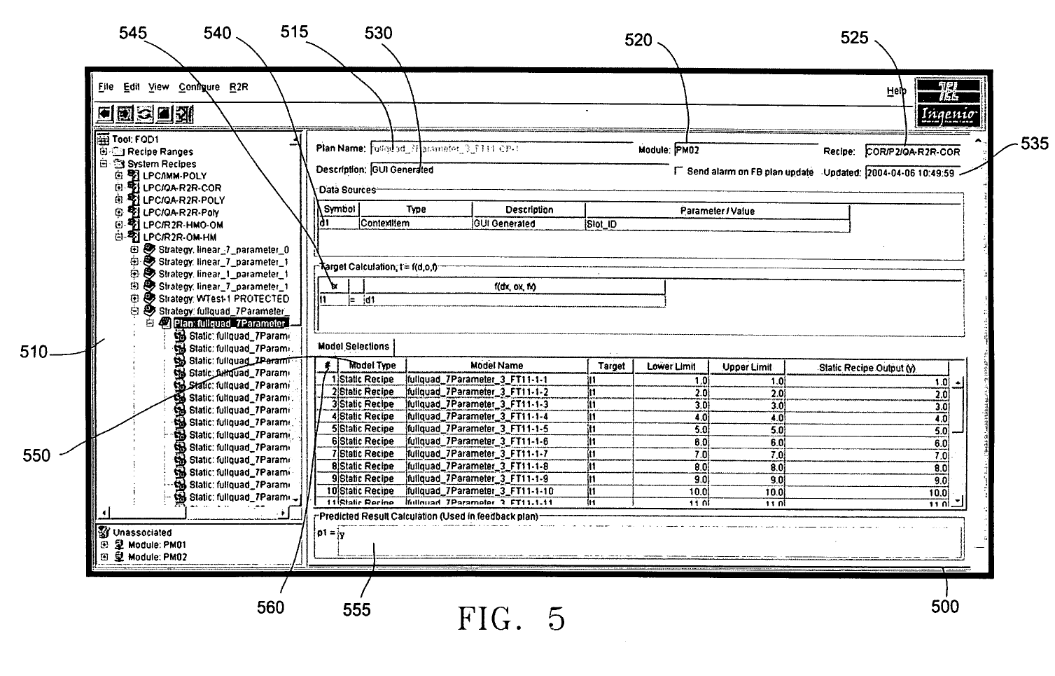

FIG. 5 illustrates an exemplary view of control plan screen 500 in accordance with an embodiment of the invention. In FIG. 5, a DOE Control Plan screen 500 is shown for a control plan for managing a set of static recipes for a DOE process. Alternately, other processes can be used.

To create a Control Plan, a user can select the plan name item and select a new Control Plan or an existing plan or model. For example, on the control strategy screen 510, a drop-down menu can appear and the Add Plan selection can be chosen.

A DOE control plan screen 500 can include a number of fields. The Plan Name field 515 can be used to enter/edit a name for a DOE control plan. A Module field 520 can be used to enter/edit a module name. For example, if the plan is associated with a strategy, the module field may be automatically filled in. If the plan is unassociated, the module field can be used to select a process module. The Recipe field 525 can be used to enter/edit a recipe. For example, if the plan is associated with a strategy, the recipe field may be automatically filled in. If the plan is unassociated, the field can be used to select a recipe.

The Description field 530 can be used to enter/edit a description for the plan. The Updated field 535 displays the last time the plan was changed.

The Data Source table 540 can be used to enter/edit a data source. For example, a DOE Plan Data Source screen may be opened. The Data source table 540 can include a source type, a data source description, and a data source parameter/value. For example, the selected source type determines the options displayed on the Data Source screen; a “Telius ODP” type can be used to define integrated metrology module data sources that are part of the processing tool; a “Desired Output” type allows the user to enter a fixed unit for the controller; a “Feedback Offset” type allows the user to define a persistent feedback variable; a “Control Plan Value” allows the user to create a variable that references the results of a different control plan (creates nested plans); the “Integrated Metrology Site Filtering” type creates tables with descriptions of each option when each data source is selected; and a “ContextItem” type allows a user to create a variable that references a context item, such as a Slot_Id, a Wafer_id, or a wafer number.

The symbol can be selected from the Symbol drop-down list, and a source type can be selected from the Data Source Type drop-down menu. For example, the data source information fields can vary depending on the chosen data source.

One input data source (d1) is shown, but this is not required. A different number of input data sources can be used, and each input data source can have a different symbol value. For example, one data source can be an ODP tool, and it can be part of the processing tool, such as a Telius®. In addition, another data source can be a SEM, and the Parameter/Value can be actual measured data such as a CD-SEM data.

In the target calculation field 545, on a DOE Control Plan screen, the target calculation can be entered. For example, the target calculation can be set equal to the data source item. Alternately, an equation may be entered that correlates one set of data with another set of data. In addition, target calculation field 545 may include an additional compensation term. For example, the additional compensation factor can be used to correct for processing that occurs in another step, such as a gate stack etch step. A new target value can be a variable that is calculated at or before run time, and an equation can be used to calculate the target value.

In addition, new lower and upper limit values can be used, and these values can be entered in the lower limit field and upper limit field. For example, the new lower and upper limit values can be constants or variables that are calculated at or before run time, and equations can be used to calculate the new lower and upper limit values.

The Model Selections field 550 can be used to edit/enter a static model and/or a formula model. For example, under the model type selection item, a selection item in the table can be used to enter and/or edit a model type. A drop down list can be activated from the table item and a selection can be made from the drop down list. One option in the drop down list allows a new model to be created; other options can be used to display and select existing models to use or to modify. Each model type can have a module name, target value, lower limit, upper limit, and recipe output associated with it. When creating a new model, a new model type can be used and entered in the model type field, and a new model name can be used and entered in the model name field.

The Predicted Result Calculation field 555 can be used to enter a new predicted result value or select an existing predicted result value. The predicted result value can be an equation for the expected result. For example, a Control Plan can be saved when Name, Target Calculation, and Model Selection information is entered.

The # field 560 includes a number of the model in the list of models. The model type allows either a Static or a Formula model to be selected. The Model Name field lists the names of available models. For example, to create a new model, a “New Static Recipe” option or a “New Formula Recipe” option can be selected from a drop down list. A static control plan can be created that comprises one or more static recipes. For example, ten or more static models can be shown. The static models are shown with the same target value (t1), but this is not required. A different number of static and/or formula models can be used, and each model can have a different target value. A new target value can be calculated when each static recipe is used. As shown in FIG. 5, the static recipe models can have different operating ranges as defined by the lower limit values and the upper limit values. In addition, the static recipe models can have different static recipe outputs, and a different static recipe output can be determined for each static recipe.

A process recipe can include one or more processes each having one or more processing steps. The process recipe can be performed in a single chamber or multiple chambers. The process recipe can be configured using at least one of a nominal recipe, a static recipe, and a formula model.

A static recipe can be a single set of recipe adjustments that are used to achieve a specific process result. A set of static recipes can be used to set up a table-based controller, or static recipes can be used along with formula models to treat ranges of the desired output where the same recipe should be used. When using feedback with static recipes, a single predicted process result can be specified in the control plan for each static recipe used. A formula model can include a pre-model adjustment, a model equation, a series of post model adjustments, and a recipe parameter assignment map. The pre-model adjustment can allow the re-expression of the desired process result (usually t1) into the correct units that are used in a model equation (resulting in a value of y), and the model equation can be an expression that calculates the predicted process result as a function of one manipulated variable (x). When the model is executed, it will solve for x given the re-expressed desired process result (y). Once x is determined, the post model adjustments can be calculated, and their values will be assigned to the appropriate recipe parameters specified in the recipe parameter map.

In addition, one or more process models can be provided. A process model can be used to define a process space. A process model represents the verified relationship between the desired results (outputs) and the received variables needed to achieve those results. Process models can include equations that can include formula-based models. Formula-based models can include equations that contain the piecewise associations of desired results with recipe variables based on some evaluated experimental data. A process model can be linear or non-linear. A process model can be used to verify a new process recipe, and update an existing process recipe.

FIGS. 6A-6C illustrate exemplary views of R2R Static Recipe Editor Screens 600 in accordance with one embodiment of the present invention. In the illustrated embodiment shown in FIG. 6A, one DOE related static recipe “CORFullQuadratic7paramters-14” is shown in the name field 605. Alternately, different models and/or recipes can be shown.

The Recipe Range field 610 includes “COR-Range” which can be related to a particular process such as a process performed using a DOE methodology, and the Description field can comprise a description for a static recipe. Constants can be used in formula models to replace values in the static recipes. The Recipe Range is used to provide lower and upper limits for the variables associated with a static recipe.

In the illustrated embodiments, a number of process parameters (variables) and a number of process steps are shown, but these are not required for the invention. In alternate embodiments, different process parameters and different process steps can be used.

In the illustrated embodiments, ten process variables are shown in the display field 615, but this is not required. Alternately, a different number of process variables may be used. In addition, seven of the process variables are changed during the different DOE experiments.

In the illustrated embodiments, a full quadratic model is being used, seven process variables are being changed, and fourteen experiments are being performed.

FIG. 6A shows an example of a static recipe that can be used during the first DOE experimental run. FIG. 6B shows an example of a static recipe that can be used during the seventh DOE experimental run. FIG. 6C shows an example of a static recipe that can be used during the fourteenth DOE experimental run.

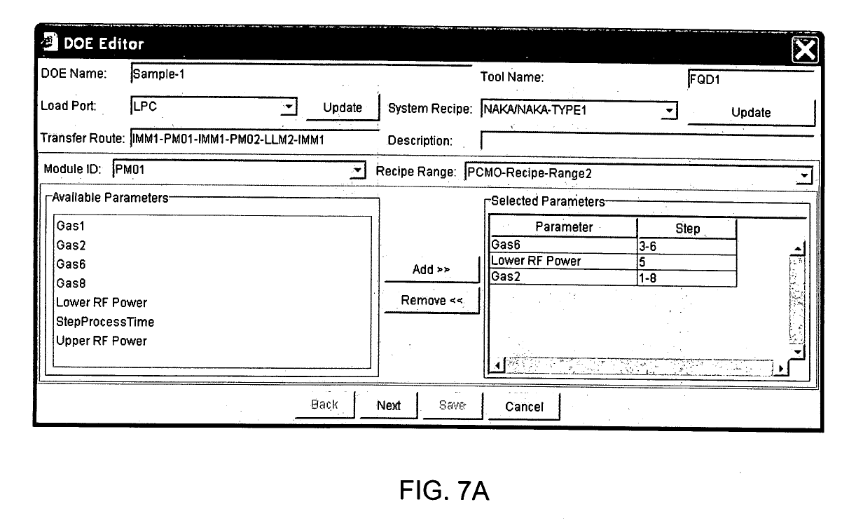

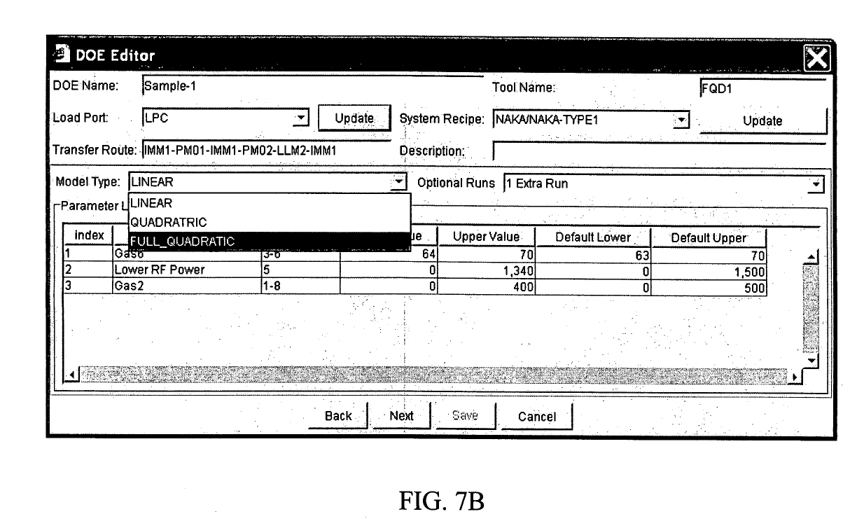

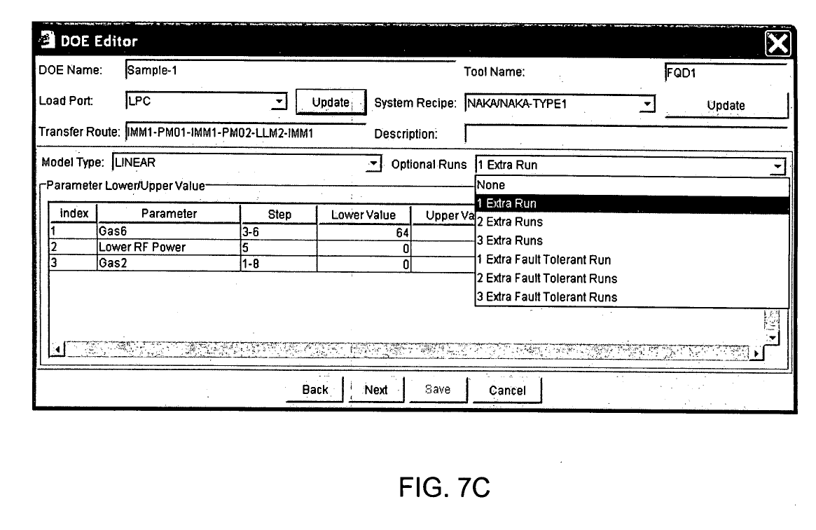

FIGS. 7A-7C illustrate DOE Editor Screens 700 in accordance with an embodiment of the invention. In the illustrated embodiment, a number of fields can be provided to create and/or edit a DOE model using a run-to-run (R2R) controller. A DOE name field 705 can include the name of a DOE model, and this field can be editable. A tool name field 710 can include the name of the processing tool that the DOE model is associated with.

A Load Port field 715 can be used to obtain a list of load port information from the processing tool. A Load Port Update Button 720 can be used as a refresh function, and can be used to obtain the current load port information from the processing tool.

A System Recipe field 725 can be used to obtain a list of system recipes from the processing tool. A System Recipe Update button 730 can be used as a refresh function, and can be used to obtain the current recipe information from the processing tool. The system recipe range information can be obtained by context matching one or more context items, such as the tool name. For example, a drop down list 732 can be used to select a system recipe when a new DOE model is being created or edited. The drop down list can include a list of system recipes from a table in the database, and the items on the list are those that context match the tool name.

A Transfer Route field 735 can be used to obtain the transfer route for selected load port and system recipe from the processing tool. For example, a transfer route can be used to determine when a wafer is transferred into an integrated metrology module (IMM), and when a wafer is being processed in a process module (PMxx). A Description field can be used to provide a description for the DOE model.

The transfer route can show that the wafers go to an IM module for a pre-process measurement and post process measurements. During a DOE process, one or more integrated metrology modules (IMM) can be used. In the illustrated embodiment, the transfer route shows a six-step process (IMM1-PM01-IMM1-PM02-LLM2-IMM1), but this is not required for the present invention. In alternate embodiments of the present invention, different transfer routes may be used, and different modules may be used.

A Model type field 740 can be used to enter and/or edit the type of model that is being used during the DOE process. The Model type can be selected using a drop down list that can include linear model, a quadratic model, and a full quadratic model. Alternately, other model types may be used. In one embodiment of the present invention, the system includes a number of linear models having different numbers of process variables associated with them, a number of quadratic models having different numbers of process variables associated with them, and a number of full-quadratic models having different numbers of process variables associated with them.

An Optional Runs field 745 can be used to enter and/or edit the number of optional runs to use during the DOE process. The number of optional runs can be selected using a drop down list 748 that can include none, 1 Extra Run, 2 extra runs, 3 extra runs, 1 extra fault tolerant run, 2 extra fault tolerant runs, and 3 extra fault tolerant runs. Alternately, a different number of optional runs may be used.

Referring to FIG. 7A, an Available Parameters field 750 can be used to identify a set of process parameter from the recipe range for the recipe that is be used to process the wafer. The list of parameters can be obtained from the recipe range associated with the selected system recipe.

An “Add >>” Button 755 can be used to add a process parameter to the selected parameter table. The number of selected parameters can be restricted and a warning can be used to when the number is exceeded. For example, a pop-up warning can be made visible when more than eight parameters are selected.

A “Remove <<” Button 760 can be used to remove the selected parameter from the selected parameter table. For example, one or more selections can be removed at a time.

Referring to FIGS. 7B and 7C, a selected parameters table 765 can be used to display the parameters that can be varied during the DOE modeling process. The Selected parameters table 765 can include a Parameter column 768 that contains one or more selected parameters from the list. The parameter can be duplicated in the list because they may correspond to different steps in a process recipe. The Selected parameters table 765 can include a Step column 770 that can contain the specific step number for each selected parameter.

A Parameter Lower/Upper Value table can be used to provide additional parameter information. Index column 772 can be used to represent the sequence order in the selected parameter table from recipe selection screen. This data is not editable. The Parameter column 768 can be used to show the list of parameters that were selected from the recipe range. This data is not editable. The Step column 770 can be used to show the list of step information for each parameter from recipe range selection screen. This data is not editable. The Lower value column 774 can be used to establish a lower value for one or more parameters during one or more steps in the selected system (process) recipe. The lower value is equal to or higher than the default value in the selected recipe range for that parameter. The data in this column is editable data. The Upper value 776 can be used to establish an upper value for one or more parameters during one or more steps in the selected system (process) recipe. The upper value can be equal to or lower than the default value in the selected recipe range for that parameter. The data in this column is editable data. The Default Lower column 778 can be used to list the default lower value for one or more of the selected parameters in the selected recipe range. The Default Upper column 780 can be used to list the default lower value for one or more of the selected parameters in the selected recipe range.

In FIGS. 7A-7C, a number of buttons are shown. A Next Button 785 can be used to activate a model selection screen, and a validation check can be performed to ensure that the step information is valid for each parameter. The Cancel button 788 can be used to exit the editor screen. The Save button 790 can be used to save the current configuration for the DOE model.

The simplest way to select trials for an experiment is to spread the trials out by placing them on corners, centers of faces etc. Optimal designs use a different method for spreading the points out, and this can result in experiments that are more efficient. First, an “optimal” property must be chosen. D-Optimal designs, for instance, focus on finding the best b-coefficients for a model. I-Optimal designs focus on finding the best predictions from a model. Second, this optimality must be stated mathematically. D-Optimal designs maximize the determinant of the variance-covariance matrix. I-Optimal designs minimize the integrated variance for the region of interest. Finally, experimental trials can be chosen to satisfy the appropriate mathematical criterion. This method can be very complicated and is generally executed by a computer. The GOSSET program can be used to generate optimal designs.

One principle behind good experiment designs is that the trials are well spread out from each other. The way the trials are spread out and the model to be fitted create different types of designs. Designs can include Factorial Designs, Fractional Factorial Designs, Central Composite Designs, Face-Centered Cubic Designs, Uniform Shell Designs, D-Optimal Designs, and I-Optimal Designs.

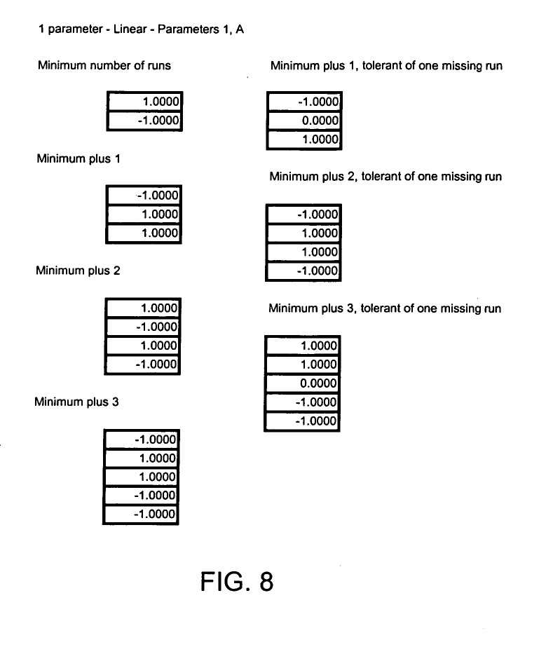

FIG. 8 illustrates tables of a number of experimental runs for a linear model that includes a single parameter. In the illustrated embodiment, a parameter table is shown for a minimum number of runs, a minimum number of runs plus 1, a minimum number of runs plus 2, a minimum number of runs plus 3, a minimum number of runs plus 1 and tolerant of one missing run, a minimum number of runs plus 2 and tolerant of one missing run, a minimum number of runs plus 3 and tolerant of one missing run.

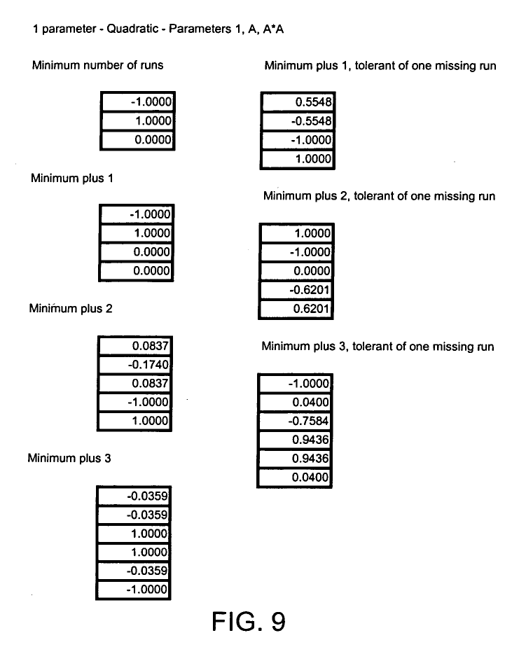

FIG. 9 illustrates tables of a number of experimental runs for a quadratic model that includes a single parameter. In the illustrated embodiment, a parameter table is shown for a minimum number of runs, a minimum number of runs plus 1, a minimum number of runs plus 2, a minimum number of runs plus 3, a minimum number of runs plus 1 and tolerant of one missing run, a minimum number of runs plus 2 and tolerant of one missing run, a minimum number of runs plus 3 and tolerant of one missing run.

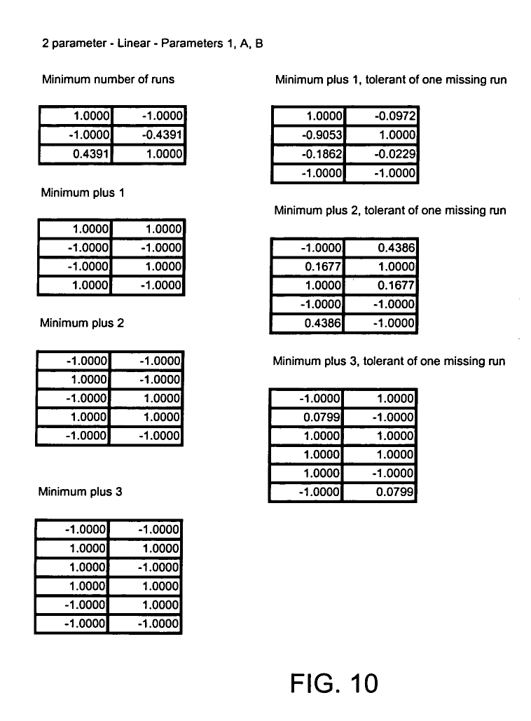

FIG. 10 illustrates tables of a number of experimental runs for a linear model that includes two parameters. In the illustrated embodiment, a parameter table is shown for a minimum number of runs, a minimum number of runs plus 1, a minimum number of runs plus 2, a minimum number of runs plus 3, a minimum number of runs plus 1 and tolerant of one missing run, a minimum number of runs plus 2 and tolerant of one missing run, a minimum number of runs plus 3 and tolerant of one missing run.

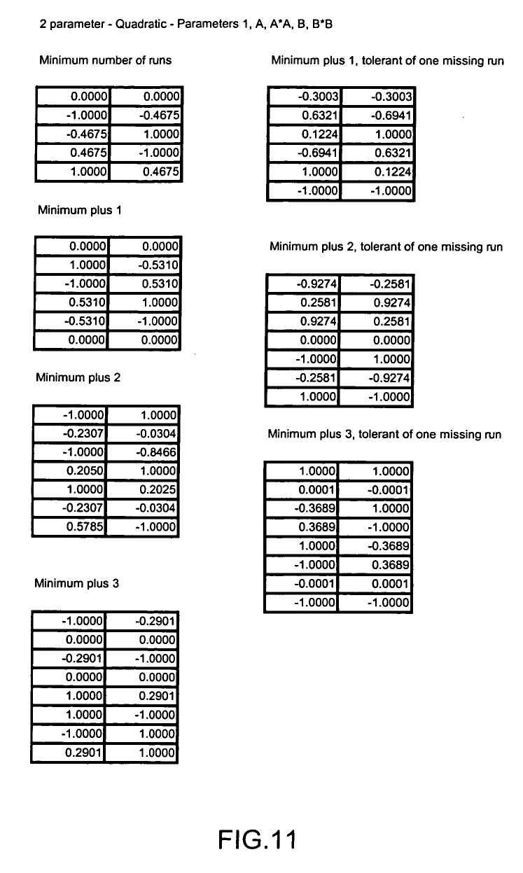

FIG. 11 illustrates tables of a number of experimental runs for a quadratic model that includes two parameters. In the illustrated embodiment, a parameter table is shown for a minimum number of runs, a minimum number of runs plus 1, a minimum number of runs plus 2, a minimum number of runs plus 3, a minimum number of runs plus 1 and tolerant of one missing run, a minimum number of runs plus 2 and tolerant of one missing run, a minimum number of runs plus 3 and tolerant of one missing run.

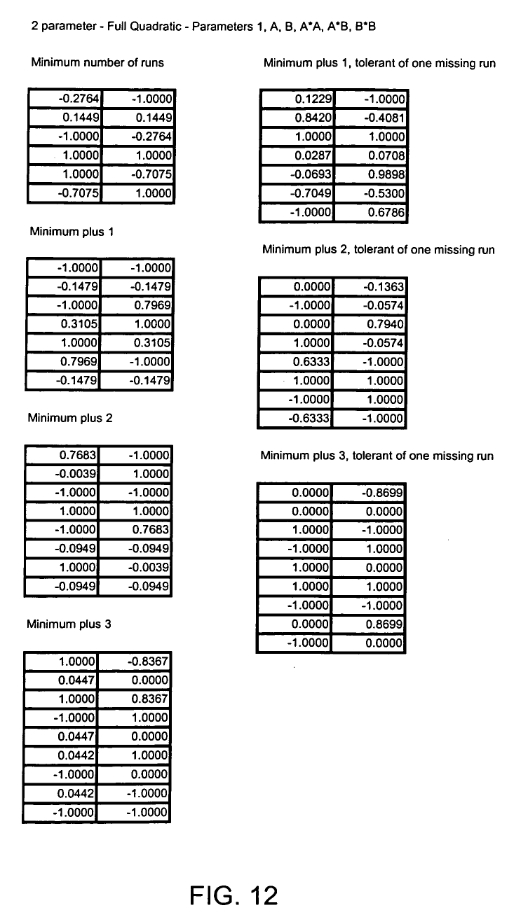

FIG. 12 illustrates tables of a number of experimental runs for a full-quadratic model that includes two parameters. In the illustrated embodiment, a parameter table is shown for a minimum number of runs, a minimum number of runs plus 1, a minimum number of runs plus 2, a minimum number of runs plus 3, a minimum number of runs plus 1 and tolerant of one missing run, a minimum number of runs plus 2 and tolerant of one missing run, a minimum number of runs plus 3 and tolerant of one missing run.

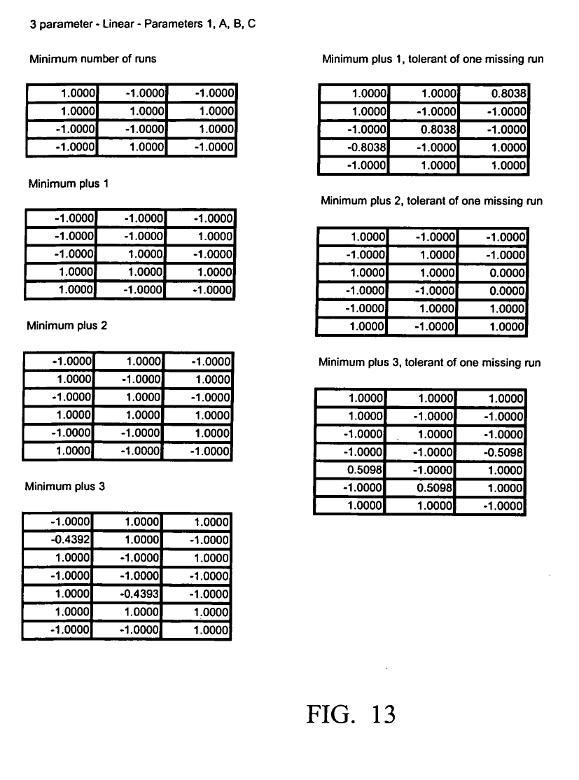

FIG. 13 illustrates tables of a number of experimental runs for a linear model that includes three parameters. In the illustrated embodiment, a parameter table is shown for a minimum number of runs, a minimum number of runs plus 1, a minimum number of runs plus 2, a minimum number of runs plus 3, a minimum number of runs plus 1 and tolerant of one missing run, a minimum number of runs plus 2 and tolerant of one missing run, a minimum number of runs plus 3 and tolerant of one missing run.

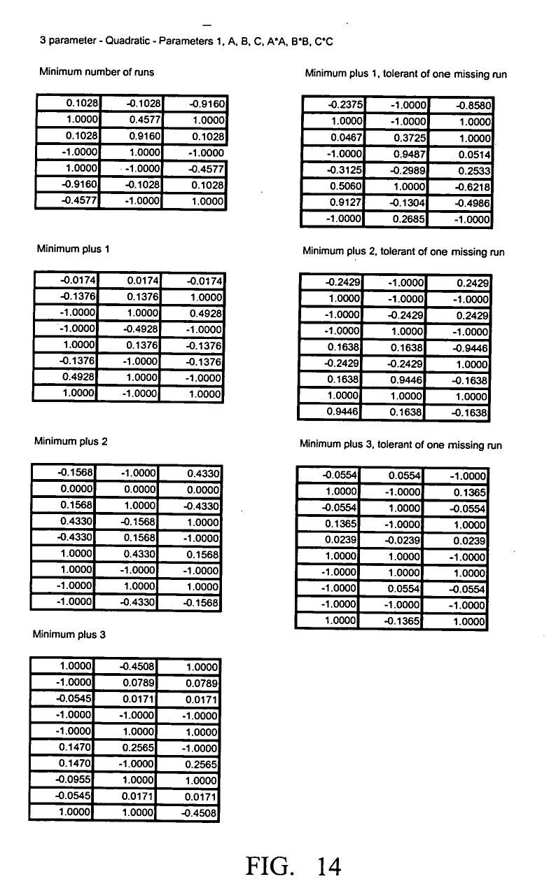

FIG. 14 illustrates tables of a number of experimental runs for a quadratic model that includes three parameters. In the illustrated embodiment, a parameter table is shown for a minimum number of runs, a minimum number of runs plus 1, a minimum number of runs plus 2, a minimum number of runs plus 3, a minimum number of runs plus 1 and tolerant of one missing run, a minimum number of runs plus 2 and tolerant of one missing run, a minimum number of runs plus 3 and tolerant of one missing run.

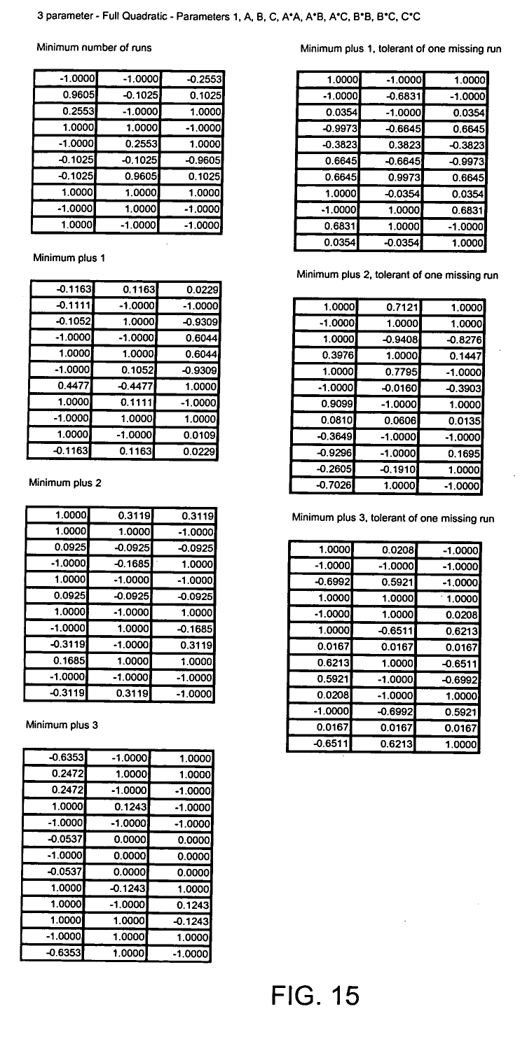

FIG. 15 illustrates tables of a number of experimental runs for a full-quadratic model that includes three parameters. In the illustrated embodiment, a parameter table is shown for a minimum number of runs, a minimum number of runs plus 1, a minimum number of runs plus 2, a minimum number of runs plus 3, a minimum number of runs plus 1 and tolerant of one missing run, a minimum number of runs plus 2 and tolerant of one missing run, a minimum number of runs plus 3 and tolerant of one missing run.

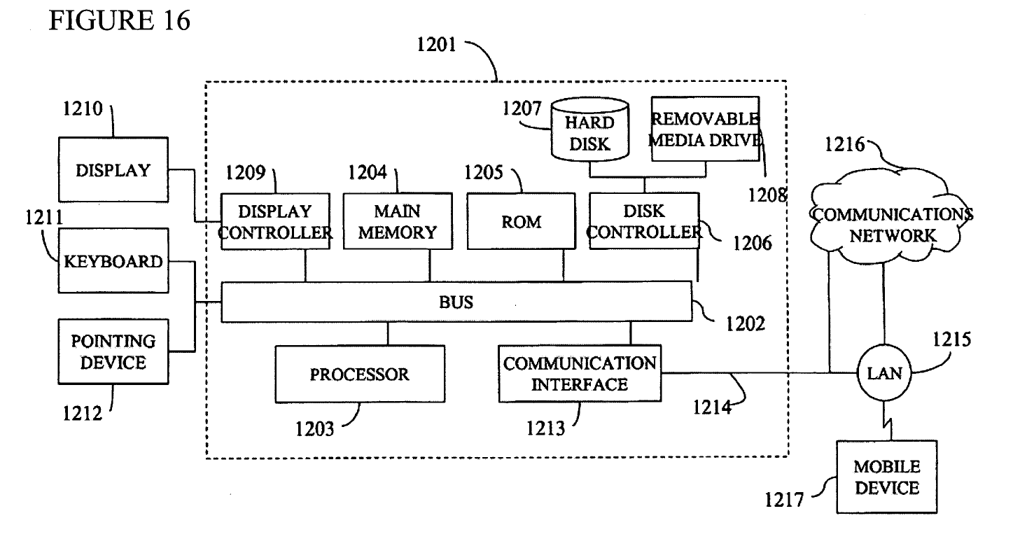

FIG. 16 illustrates one embodiment of a computer system 1201 in which the processing tool 110, the control processor 120, and the MES 130 of the present invention can be implemented. The computer system 1201 is programmed and/or configured to perform any or all of the functions described above. The computer system 1201 includes a bus 1202 or other communication mechanism for communicating information, and a internal processor 1203 coupled with the bus 1202 for processing the information. The computer system 1201 includes a memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by the internal processor 1203. In addition, the memory 1204 may be used for storing temporary variables or other intermediate information during the execution of instructions by the internal processor 1203. The computer system 1201 preferably includes a non-volatile memory such as for example a read only memory (ROM) 1205 or other static storage device (e.g., programmable ROM (PROM), erasable PROM (EPROM), and electrically erasable PROM (EEPROM)) coupled to the bus 1202 for storing static information and instructions for the internal processor 1203.

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)). The computer system may also include one or more digital signal processors (DSPs) such as the TMS320 series of chips from Texas Instruments, the DSP56000, DSP56100, DSP56300, DSP56600, and DSP96000 series of chips from Motorola, the DSP1600 and DSP3200 series from Lucent Technologies or the ADSP2100 and ADSP21000 series from Analog Devices. Other processors especially designed to process analog signals that have been converted to the digital domain may also be used.

The computer system 1201 performs a portion or all of the processing steps of the invention in response to the internal processor 1203 executing one or more sequences of one or more instructions contained in a memory, such as the main memory 1204. Such instructions may be read into the main memory 1204 from another computer readable medium, such as a hard disk 1207 or a removable media drive 1208. Such instructions may be read into or from the main memory 1204 from another computer readable medium, such as from USB flash drives or jump drives. Such drives are sold-state memory devices which can act as floppy disks or hard drives under most computer operating systems. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media suitable for the present invention are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read. Such memory can include the above-noted jump drives.

Stored on any one or on a combination of computer readable media, the present invention includes software for controlling the computer system 1201, for driving a device or devices for implementing the invention, and for enabling the computer system 1201 to interact with a human user (e.g., to interact with consumable part disposal personnel). Such software may include, but is not limited to, device drivers, operating systems, development tools, and applications software. Such computer readable media further includes the computer program product of the present invention for performing all or a portion (if processing is distributed) of the processing performed in implementing the present invention. Examples in the present invention of data stored in these memory devices include the data in the input element 225, the database 230, the process module 230, the pre-process data 245, and the post-process data 250.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the internal processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to internal processor 1203 for execution. For example, the instructions may initially be carried on a disk to a remote computer. The computer such as for example the process controller 120 can load the instructions for implementing all or a portion of the present invention remotely into a dynamic memory and send the instructions to the processing tool 110. An infrared detector coupled to the bus 1202 can receive the data carried in the infrared signal and place the data on the bus 1202. The bus 1202 carries the data to the main memory 1204, from which the internal processor 1203 retrieves and executes the instructions. The instructions received by the main memory 1204 may optionally be stored on storage device 1207 or 1208 either before or after execution by the internal processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214, and the communication interface 1213. Links 112, 114, 122, and 124 can be used, as described earlier, for communications over these devices between various controllers and processing tools and the MES 130. Moreover, the network link 1214 may provide a connection through a LAN 1215 to a mobile device 1217 such as a personal digital assistant (PDA) laptop computer, or cellular telephone.

Thus, in one embodiment of the present invention, there is a computer readable medium containing program instructions for execution on a computer system associated with operation of processing system. When executed by the computer system, the computer system(s) operating the processing system 100:

(1) receive a selection of a process model from a menu of process models available for characterization of a processing tool of the processing system,

(2) design a number of process runs to characterize the selected process model on the processing tool,

(3) direct process runs on the processing tool to collect data for input to the selected process model,

(4) obtain actual process results from the process runs, and

(5) solve for coefficients of the process model.

Further, the computer-implemented method can invert the process model to determine recipe parameters required to produce a desired process result. The computer-implemented method in receiving a selection can provide for the selection at least one of a linear model, a quadratic model, and a full-quadratic model. The computer-implemented method in receiving a selection can provide a drop down list of at least one of the linear model, the quadratic model, and the full-quadratic model.

The computer-implemented method can define process runs in which at least one process parameter is varied by a set amount about a nominal operating point during each process run, can determine at least one process model parameter in the process model, can determine a minimum number of runs for solution of the coefficients, and can determine one more to three more than the minimum number of runs for solution of the coefficients. The computer-implemented method can determine one to three more than the minimum number of runs for solution of the coefficients such that the solution is tolerant to one missing run.

The computer-implemented method can form a design of experiment (DOE) control strategy and then execute at least one DOE control plan for the DOE control strategy. The computer-implemented method can form a design of experiment (DOE) control strategy by downloading a plurality of control plans and displaying stored control plans for user selection and editing. The computer-implemented method can display a navigation tree having sublevels of the stored control plans. The computer-implemented method can provide on-display editing of a selected one of the displayed control plans.

The computer-implemented method can display on at least one graphical user interface (GUI) screen at least one of a DOE control strategy screen, a DOE control plan screen, a recipe range screen, a process recipe screen, or a status screen, or a combination thereof. The computer-implemented method can generate process recipes (e.g., by recall from memory or by user interaction and editing of recalled process recipes), and send the process recipes to the processing system. The computer-implemented method can provide a displayed recipe field at least one recipe from a list of recipes for the processing tool, and can provide a refresh button to obtain current recipe information for the processing tool.

The computer-implemented method can form a DOE data collection plan to determine the required number of process runs, and the direct data collection specified by the DOE data collection plan. The computer-implemented method can provide an editable field in a graphics unit interface for entry of a DOE collection plan name. The computer-implemented method can provide a dropdown list of system recipes for the processing tool to be associated with the DOE collection plan name.

The computer-implemented method can execute a DOE data analysis plan on the collected data. The computer-implemented method can determine if the collected data is correct, and determine if a sufficient amount of data has been collected for solution of the coefficients. The computer-implemented method can solve a set of equations associated with the process runs. For the set of equations, an equation is established for each of the process runs, and process model coefficients are used as the variables in the set of equations. The computer-implemented method can execute the process model to predict a process result. The computer-implemented method can display a multi-dimensional graph of the process model. The computer-implemented method can direct the process runs in at least one of an etching module, a deposition module, a polishing module, a coating module, a developing module, a thermal treatment module, and a combination of two or more thereof.

Further, in another embodiment of the present invention, there is a computer-directed system for performing design of experiments techniques on a processing tool. The computer-directed system includes a selection device (e.g., the control strategy screen 400, the control plan screen 500, the R2R Static Recipe Editor Screens 600) having a menu of process models available for selection, a process controller (e.g., process controller 120) coupled to the processing tool (e.g., processing tool 110) for control of the processing tool, a receiver configured to receive process data from executed process runs, and a data processor configured to receive the process data and solve for coefficients of the process model. The process controller is configured to receive from the selection device a selected process model, and includes a memory storing a determination algorithm for determination of a number of process runs required for characterization of the selected process model on the processing tool.

The memory in the process controller can include an inverter algorithm for inversion of the process model to determine recipe parameters for a desired process result. The process models in the process controller can include at least one of a linear model, a quadratic model, and a full-quadratic model. The determination algorithm can include an algorithm for definition of process runs in which at least one process parameter is varied by a set amount about a nominal operating point during each process run.

The memory in the process controller can include a design of experiments (DOE) control strategies and DOE control plans for execution of the DOE control strategies on the process tool. The memory in the process controller can include a design of experiments (DOE) collection plan and a DOE control plan for execution of the DOE collection plan on the process tool.

The data processor can include a memory having a solution algorithm for solution of a set of equations associated with each process run. The solution algorithm can include model coefficients to be used as variables in the set of equations.

The computer-directed system can include a display configured to display a multi-dimensional graph of the process model. The process controller can be configured to execute the process model to predict a process result. The memory in the process can include a process recipe algorithm that generates process recipes for control of the processing tool.

The computer-directed system can include a graphical user interface (GUI) screen configured to display a DOE control strategy screen, a DOE control plan screen, a recipe range screen, a process recipe screen, or a status screen, or a combination thereof, as illustratively shown in FIGS. 4-7C. The computer-directed system can be coupled to at least one of an etching module, a deposition module, a polishing module, a coating module, a developing module, and a thermal treatment module.

Although only certain embodiments of this invention have been described in detail above, those skilled in the art will readily appreciate that many modifications are possible in the embodiments without materially departing from the novel teachings and advantages of this invention. Accordingly, all such modifications are intended to be included within the scope of this invention.

1. A computer-implemented method for operation of a processing system, comprising:
receiving a selection of a process model from a menu of process models available for characterization of a processing tool of the processing system;
designing a number of process runs to characterize the selected process model on the processing tool;
directing the process runs on the processing tool to collect data for input to the selected process model;
obtaining actual process results from the process runs; and
solving for coefficients of the process model.

2. The computer-implemented method as claimed in claim 1, further comprising:
inverting the process model to determine recipe parameters required to produce a desired process result.

3. The computer-implemented method as claimed in claim 1, wherein the receiving a selection comprises:
providing for the selection at least one of a linear model, a quadratic model, and a full-quadratic model.

4. The computer-implemented method as claimed in claim 3, wherein the providing for the selection comprises:
providing a drop down list of at least one of the linear model, the quadratic model, and the full-quadratic model.

5. The computer-implemented method as claimed in claim 1, wherein the designing comprises:
defining process runs in which at least one process parameter is varied by a set amount about a nominal operating point during each process run.

6. The computer-implemented method as claimed in claim 1, wherein the designing comprises:
determining at least one process model parameter in the process model.

7. The computer-implemented method as claimed in claim 1, wherein the designing comprises:
determining a minimum number of runs for solution of the coefficients.

8. The computer-implemented method as claimed in claim 1, wherein the designing comprises:
determining one more than a minimum number of runs for solution of the coefficients.

9. The computer-implemented method as claimed in claim 1, wherein the designing comprises:
determining two more than a minimum number of runs for solution of the coefficients.

10. The computer-implemented method as claimed in claim 1, wherein the designing comprises:
determining three more than a minimum number of runs for solution of the coefficients.

11. The computer-implemented method as claimed in claim 1, wherein the designing comprises:
determining one more than the minimum number of runs for a solution that is tolerant to one missing run.

12. The computer-implemented method as claimed in claim 1, wherein the designing comprises:
determining two more than the minimum number of runs for a solution that is tolerant to one missing run.

13. The computer-implemented method as claimed in claim 1, wherein the designing comprises:
determining three more than the minimum number of runs for a solution that is tolerant to one missing run.

14. The computer-implemented method as claimed in claim 1, wherein the designing comprises:
selecting from a displayed recipe field at least one recipe from a list of recipes for the processing tool.

15. The computer-implemented method as claimed in claim 14, wherein the selecting at least one recipe comprises:
selecting a refresh button to obtain current recipe information for the processing tool.

16. The computer-implemented method as claimed in claim 1, wherein the designing comprises forming a design of experiment (DOE) control strategy having at least one DOE control plan, and
wherein the directing comprises executing the at least one DOE control plan.

17. The computer-implemented method as claimed in claim 1, wherein the designing comprises:
forming a design of experiment (DOE) control strategy by downloading a plurality of control plans; and
displaying stored control plans for user selection and editing.

18. The computer-implemented method as claimed in claim 17, further comprising:
displaying a navigation tree having sublevels of the stored control plans.

19. The computer-implemented method as claimed in claim 17, further comprising:
on-display editing of a selected one of the displayed control plans.

20. The computer-implemented method as claimed in claim 1, further comprising:
displaying on at least one graphical user interface (GUI) screen at least one of a DOE control strategy screen, a DOE control plan screen, a recipe range screen, a process recipe screen, or a status screen, or a combination thereof.

21. The computer-implemented method as claimed in claim 1, wherein the designing a number of process runs and the directing the process runs comprise:
obtaining process recipes; and
sending the process recipes to the processing system.

22. The computer-implemented method as claimed in claim 1, wherein the designing comprises:
forming a DOE data collection plan for a required number of process runs; and
collecting data specified by the DOE data collection plan.

23. The computer-implemented method as claimed in claim 22, further comprising:
executing a DOE data analysis plan on the collected data.

24. The computer-implemented method as claimed in claim 23, further comprising:
determining if the collected data is correct; and
determining if a sufficient amount of data has been collected for solution of the coefficients.

25. The computer-implemented method as claimed in claim 23, wherein the forming a DOE data collection plan comprises:
providing an editable field in a graphics unit interface for entry of a DOE collection plan name.

26. The computer-implemented method as claimed in claim 25, further comprising:
providing a dropdown list of system recipes for the processing tool to be associated with the DOE collection plan name.

27. The computer-implemented method as claimed in claim 1, further comprising:
solving a set of equations associated with the process runs such that, for said set of equations, an equation is established for each of the process runs and process model coefficients are used as the variables in the set of equations.

28. The computer-implemented method as claimed in claim 1, further comprising:
executing the process model to predict a process result.

29. The computer-implemented method as claimed in claim 1, further comprising:
displaying a multi-dimensional graph of the process model.

30. The computer-implemented method as claimed in claim 1, wherein the directing comprises:
directing the process runs in at least one of an etching module, a deposition module, a polishing module, a coating module, a developing module, a thermal treatment module, and a combination of two or more thereof.

31. A computer readable medium containing program instructions for execution on a computer system, which when executed by the computer system, cause the computer system to perform any one of the steps of claims 1-30.

32. A processing system comprising:
a processing module; and
a controller coupled to the processing module, wherein the controller comprises means for performing a substantially automatic design of experiments (DOE) procedure,
said means for performing a substantially automatic DOE procedure including,
means for selecting a process model,
means for designing an experiment to collect process data using the selected process model,
means for collecting the data when the number of process runs are performed, and
means for determining coefficients for the selected process model using the collected data.

33. The processing system as claimed in claim 32, wherein the controller comprises a DOE control strategy and means for executing the DOE control strategy, and
wherein the DOE control strategy comprises a DOE control plan and the controller comprises means for executing the DOE control plan.

34. The processing system as claimed in claim 32, wherein the controller comprises a DOE control strategy and a means for executing the DOE control strategy, and
wherein the DOE control strategy comprises a DOE data collection plan and the controller comprises means for executing the DOE collection plan.

35. The processing system as claimed in claim 32, wherein the controller comprises a DOE control strategy and means for executing the DOE control strategy, and
wherein the DOE control strategy comprises a DOE analysis plan and the controller comprises means for executing the DOE analysis plan.

36. The processing system as claimed in claim 32, wherein the means for determining the model coefficients comprises:
means for solving a set of equations such that an equation is established for each process run and the model coefficients are used as the variables in the set of equations.

37. The processing system as claimed in claim 24, wherein the controller comprises:
means for displaying a multi-dimensional graph of the process model.

38. The processing system as claimed in claim 32, wherein the controller comprises:
means for executing the process model to predict a process result.

39. The processing system as claimed in claim 32, wherein the controller comprises:
means for creating process recipes and sending the process recipes to the processing module.

40. The processing system as claimed in claim 32, wherein the controller comprises means for displaying a plurality of graphical user interface (GUI) screens, and
wherein the GUI screens comprise a DOE control strategy screen, a DOE control plan screen, a recipe range screen, a process recipe screen, or a status screen, or a combination thereof.

41. The processing system as claimed in claim 32, wherein the processing module comprises an etching module, a deposition module, a polishing module, a coating module, a developing module, or a thermal treatment module, or a combination of two or more thereof.

42. A computer-directed system for performing design of experiments techniques on a processing tool, comprising:
a selection device having a menu of process models available for selection;
a process controller coupled to the processing tool for control of the processing tool, and configured to receive from the selection device a selected process model, said process controller including a memory storing a determination algorithm for determination of a number of process runs required for characterization of the selected process model on the processing tool;
a receiver configured to receive process data from executed process runs; and
a data processor configured to receive the process data and solve for coefficients of the process model.

43. The computer-directed system as claimed in claim 42, wherein the memory in the process controller comprises:
an inverter algorithm for inversion of the process model to determine recipe parameters for a desired process result.

44. The computer-directed system as claimed in claim 42, wherein the determination algorithm comprises:
an algorithm for definition of process runs in which at least one process parameter is varied by a set amount about a nominal operating point during each process run.

45. The computer-directed system as claimed in claim 42, wherein the process model comprises:
at least one of a linear model, a quadratic model, and a full-quadratic model.

46. The computer-directed system as claimed in claim 45, wherein the selection device comprises:
a drop down list of at least one of the linear model, the quadratic model, and the full-quadratic model.

47. The computer-directed system as claimed in claim 42, wherein the selection device comprises:
a display configured to display a recipe field of at least one recipe from a list of recipes for the processing tool.

48. The computer-directed system as claimed in claim 42, further comprising:
a refresh button configured upon activation to obtain current recipe information for the processing tool.

49. The computer-directed system as claimed in claim 42, wherein the memory in the process controller comprises:
a design of experiments (DOE) control strategy; and
a DOE control plan for execution of the DOE control strategy on the process tool.

50. The computer-implemented system as claimed in claim 49, further comprising:
a display configured to display a navigation tree having sublevels of DOE control plans.

51. The computer-directed system as claimed in claim 42, wherein the memory in the process controller comprises:
a design of experiments (DOE) collection plan; and
a DOE control plan for execution of the DOE collection plan on the process tool.

52. The computer-directed system as claimed in claim 51, further comprising:
a display configured to display an editable field for entry of a DOE collection plan name.

53. The computer-directed system as claimed in claim 51, further comprising:
a display configured to display a dropdown list of system recipes for the processing tool to be associated with the DOE collection plan name.

54. The computer-directed system as claimed in claim 42, wherein the data processor comprises:
a memory having a solution algorithm for solution of a set of equations associated with each process run, the algorithm including model coefficients to be used as variables in the set of equations.

55. The computer-directed system as claimed in claim 42, further comprising:
a display configured to display a multi-dimensional graph of the process model.

56. The computer-directed system as claimed in claim 42, wherein the process controller is configured to execute the process model to predict a process result.

57. The computer-directed system as claimed in claim 42, further comprising:
a graphical user interface (GUI) screen configured to display a DOE control strategy screen, a DOE control plan screen, a recipe range screen, a process recipe screen, or a status screen, or a combination thereof.

58. The computer-directed system as claimed in claim 42, wherein the processing tool comprises:
at least one of an etching module, a deposition module, a polishing module, a coating module, a developing module, and a thermal treatment module.
